(19) United States
(12) Patent Application Publication
(10) Pub. No.: US 2025/0261226 A1
(43) Pub. Date: Aug. 14, 2025

(54) TECHNIQUES FOR PRIORITIZING AND HANDLING CONFLICTING READ AND WRITE COMMANDS FOR PASSIVE DEVICES

(71) Applicant: QUALCOMM Incorporated, San Diego, CA (US)

(72) Inventors: Ahmed ELSHAFIE, San Diego, CA (US); Yuchul KIM, San Diego, CA (US); Zhikun WU, Beijing (CN); Seyedkianoush HOSSEINI, San Diego, CA (US); Huilin XU, Temecula, CA (US); Linhai HE, San Diego, CA (US)

(21) Appl. No.: 18/857,148

(22) PCT Filed: Jun. 29, 2022
(86) PCT No.: PCT/CN2022/102274

§ 371 Date: Oct. 15, 2024

(51) Int. Cl. H04W 72/566; H04W 72/20

(52) U.S. Cl. CPC H04W 72/569; H04W 72/20

(57) ABSTRACT

Methods, systems, and devices for wireless communications are described. A passive device (e.g., radio frequency identifier (RFID) tag) may be configured to receive a first query associated with a first operation to be performed at the passive device and a second query associated with a second operation to be performed at the passive device, where the first and second operations are associated with first and second priority levels, respectively. The first operation and the second operation may include write operations, read operations, or both. The passive device may transmit, to a first querying device, a second querying device, or both, a message indicating a status of the first operation, the second operation, or both, and may perform one of the first or second operations in accordance with the first and second priority levels and based on transmitting the message.

### CROSS REFERENCE

The present Application is a 371 national stage filing of International PCT Application No. PCT/CN2022/102274 by ELSHAFIE et al. entitled “TECHNIQUES FOR PRIORITIZING AND HANDLING CONFLICTING READ AND WRITE COMMANDS FOR PASSIVE DEVICES,” filed Jun. 29, 2022, which is assigned to the assignee hereof, and which is expressly incorporated by reference in its entirety herein.

### FIELD OF TECHNOLOGY

The following relates to wireless communications, including techniques for prioritizing and handling conflicting read and write commands for passive devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may include passive devices, such as radio frequency identifier (RFID) tags or passive Internet-of-Things (IoT) devices, to perform certain operations such as location tracking and identification. To communicate with a passive device, a querying device (e.g., UE, network entity) transmits a signal or query to the passive device to instruct the passive device to perform a read or write operation. Passive devices such as RFID tags may include relatively low-complexity devices with limited resources and processing power, and may therefore perform a limited number of read or write operations at a time.

### SUMMARY

The described techniques relate to improved methods, systems, devices, and apparatuses that support techniques for prioritizing and handling conflicting read and write commands for passive devices. Generally, aspects of the present disclosure support techniques for signaling and configurations used to resolve relative priorities for reading and writing operations at passive devices. In particular, aspects of the present disclosure are directed to rules and conditions for determining relative priorities between reading and writing operations to be performed at passive devices, and signaling from passive devices used to indicate a status or relative priority of conflicting read/write operations. For example, a passive device may receive multiple queries for performing separate read or write operations, where the separate read or write operations are associated with different priorities. The priorities may be explicitly signaled via the queries, determined based on the type of operations to be performed (e.g., write operations may be prioritized over read operations), determined based on identifiers of the querying devices which transmitted the queries, or any combination thereof. In this example, the passive device may transmit a message to the querying device(s) which transmitted the queries to indicate the status of the scheduled read/write operations (e.g., indicate which operation will be performed), and may perform one of the operations in accordance with the relative priorities.

A method for wireless communication at a passive device is described. The method may include receiving, from a first querying device, a first query associated with a first operation to be performed at the passive device, where the first operation is associated with a first priority level and includes a first write operation, a first read operation, or both, receiving, from the first querying device or a second querying device, a second query associated with a second operation to be performed at the passive device, where the second operation is associated with a second priority level and includes a second write operation, a second read operation, or both, transmitting, to the first querying device, the second querying device, or both, a message indicating a status of the first operation, the second operation, or both, and performing one of the first operation or the second operation in accordance with the first priority level and the second priority level and based on transmitting the message.

An apparatus for wireless communication at a passive device is described. The apparatus may include a processor, memory coupled with the processor, and instructions stored in the memory. The instructions may be executable by the processor to cause the apparatus to receive, from a first querying device, a first query associated with a first operation to be performed at the passive device, where the first operation is associated with a first priority level and includes a first write operation, a first read operation, or both, receive, from the first querying device or a second querying device, a second query associated with a second operation to be performed at the passive device, where the second operation is associated with a second priority level and includes a second write operation, a second read operation, or both, transmit, to the first querying device, the second querying device, or both, a message indicating a status of the first operation, the second operation, or both, and perform one of the first operation or the second operation in accordance with the first priority level and the second priority level and based on transmitting the message.

Another apparatus for wireless communication at a passive device is described. The apparatus may include means for receiving, from a first querying device, a first query associated with a first operation to be performed at the passive device, where the first operation is associated with a first priority level and includes a first write operation, a first read operation, or both, means for receiving, from the first querying device or a second querying device, a second query associated with a second operation to be performed at the passive device, where the second operation is associated with a second priority level and includes a second write operation, a second read operation, or both, means for transmitting, to the first querying device, the second querying device, or both, a message indicating a status of the first operation, the second operation, or both, and means for performing one of the first operation or the second operation in accordance with the first priority level and the second priority level and based on transmitting the message.

A non-transitory computer-readable medium storing code for wireless communication at a passive device is described. The code may include instructions executable by a processor to receive, from a first querying device, a first query associated with a first operation to be performed at the passive device, where the first operation is associated with a first priority level and includes a first write operation, a first read operation, or both, receive, from the first querying device or a second querying device, a second query associated with a second operation to be performed at the passive device, where the second operation is associated with a second priority level and includes a second write operation, a second read operation, or both, transmit, to the first querying device, the second querying device, or both, a message indicating a status of the first operation, the second operation, or both, and perform one of the first operation or the second operation in accordance with the first priority level and the second priority level and based on transmitting the message.

Some examples of the method, apparatuses, and non-transitory computer-readable medium described herein may further include operations, features, means, or instructions for receiving the first priority level via the first query and receiving the second priority level via the second query, where transmitting the message may be based on the first priority level, the second priority level, or both.

In some examples of the method, apparatuses, and non-transitory computer-readable medium described herein, the first priority level may be based on the first operation including the first write operation and the second priority level may be based on the second operation including the second read operation.

Some examples of the method, apparatuses, and non-transitory computer-readable medium described herein may further include operations, features, means, or instructions for prioritizing the first operation over the second read operation based on the first priority level being greater than the second priority level, where transmitting the message may be based on the prioritizing, and where performing one of the first operation or the second operation includes performing the first operation based on the prioritizing.

Some examples of the method, apparatuses, and non-transitory computer-readable medium described herein may further include operations, features, means, or instructions for receiving, from the first querying device, the second querying device, or an additional wireless device, control signaling indicating a priority configuration usable for determining priority levels associated with operations to be performed at the passive device and determining the first priority level, the second priority level, or both, in accordance with the priority configuration, where transmitting the message, performing one of the first operation or the second operation, or both, may be based on determining the first priority level, the second priority level, or both.

In some examples of the method, apparatuses, and non-transitory computer-readable medium described herein, the priority configuration includes one or more rules, one or more conditions, or both, for determining priority levels associated with operations to be performed at the passive device and determining the first priority level, the second priority level, or both, may be based on the one or more rules, the one or more conditions, or both.

In some examples of the method, apparatuses, and non-transitory computer-readable medium described herein, the first priority level may be based on a first operation type associated with the first operation and the second priority level may be based on a second operation type associated with the second operation.

In some examples of the method, apparatuses, and non-transitory computer-readable medium described herein, the second query may be received from the second querying device, the first priority level may be based on a first identifier associated with the first querying device, and the second priority level may be based on a second identifier associated with the second querying device.

Some examples of the method, apparatuses, and non-transitory computer-readable medium described herein may further include operations, features, means, or instructions for transmitting the message to at least the second querying device based on the first priority level being greater than the second priority level, where the message includes an indication that the passive device may be busy performing the first operation.

Some examples of the method, apparatuses, and non-transitory computer-readable medium described herein may further include operations, features, means, or instructions for transmitting the message to at least the first querying device based on the first priority level being less than the second priority level, where the message includes an indication that the passive device may have received the second query for the second operation having a higher priority than the first operation.

Some examples of the method, apparatuses, and non-transitory computer-readable medium described herein may further include operations, features, means, or instructions for transmitting, via the message, an indication of the first priority level, the second priority level, a first operation type associated with the first operation, a second operation type associated with the second operation, a first identifier associated with the first querying device, a second identifier associated with the second querying device, or any combination thereof.

In some examples of the method, apparatuses, and non-transitory computer-readable medium described herein, the second query may be received from the first querying device and the method, apparatuses, and non-transitory computer-readable medium may include further operations, features, means, or instructions for receiving, via the second query, an instruction to stop the first operation and to perform the second operation, where the passive device performs the second operation based on the instruction.

Some examples of the method, apparatuses, and non-transitory computer-readable medium described herein may further include operations, features, means, or instructions for transmitting a set of multiple messages in accordance with a periodicity, the set of multiple messages associated with a queue of operations to be performed by the passive device, the set of multiple messages including the message indicating the status of the first operation, the second operation, or both.

Some examples of the method, apparatuses, and non-transitory computer-readable medium described herein may further include operations, features, means, or instructions for receiving a set of multiple signals in accordance with the periodicity, where transmitting the set of multiple messages may be based on receiving the set of multiple signals.

In some examples of the method, apparatuses, and non-transitory computer-readable medium described herein, the message includes an indication that the passive device may be busy performing the first operation and the method, apparatuses, and non-transitory computer-readable medium may include further operations, features, means, or instructions for receiving, from the second querying device and in response to the message, a request for an identifier associated with the first querying device and transmitting a second message to the second querying device based on receiving the request, the second message indicating the identifier associated with the first querying device.

In some examples of the method, apparatuses, and non-transitory computer-readable medium described herein, performing one of the first operation or the second operation comprises performing the first operation at a first time, and the method, apparatuses, and non-transitory computer-readable medium may include further operations, features, means, or instructions for performing the second operation at a second time subsequent to the first time based on the second priority level being less than the first priority level.

In some examples of the method, apparatuses, and non-transitory computer-readable medium described herein, performing one of the first write operation or the second write operation may include operations, features, means, or instructions for adjusting one or more operational parameters at the passive device.

In some examples of the method, apparatuses, and non-transitory computer-readable medium described herein, performing one of the first read operation or the second read operation may include operations, features, means, or instructions for transmitting a data message to the first querying device, the second querying device, or both.

In some examples of the method, apparatuses, and non-transitory computer-readable medium described herein, the passive device includes a radio frequency identifier tag, a passive component of a wireless device, or both and the first querying device, the second querying device, or both, include a UE, a network entity, or both.

A method for wireless communication at a querying device is described. The method may include transmitting, to a passive device, a first query associated with a first operation to be performed at the passive device, where the first operation is associated with a first priority level and includes a first write operation, a first read operation, or both and receiving, from the passive device based on the first query, a message indicating a status of the first operation, a second operation associated with a second priority level, or both, where the status is based on the first priority level, the second priority level or both, and where the second operation includes a second write operation, a second read operation, or both.

An apparatus for wireless communication at a querying device is described. The apparatus may include a processor, memory coupled with the processor, and instructions stored in the memory. The instructions may be executable by the processor to cause the apparatus to transmit, to a passive device, a first query associated with a first operation to be performed at the passive device, where the first operation is associated with a first priority level and includes a first write operation, a first read operation, or both and receive, from the passive device based on the first query, a message indicating a status of the first operation, a second operation associated with a second priority level, or both, where the status is based on the first priority level, the second priority level or both, and where the second operation includes a second write operation, a second read operation, or both.

Another apparatus for wireless communication at a querying device is described. The apparatus may include means for transmitting, to a passive device, a first query associated with a first operation to be performed at the passive device, where the first operation is associated with a first priority level and includes a first write operation, a first read operation, or both and means for receiving, from the passive device based on the first query, a message indicating a status of the first operation, a second operation associated with a second priority level, or both, where the status is based on the first priority level, the second priority level or both, and where the second operation includes a second write operation, a second read operation, or both.

A non-transitory computer-readable medium storing code for wireless communication at a querying device is described. The code may include instructions executable by a processor to transmit, to a passive device, a first query associated with a first operation to be performed at the passive device, where the first operation is associated with a first priority level and includes a first write operation, a first read operation, or both and receive, from the passive device based on the first query, a message indicating a status of the first operation, a second operation associated with a second priority level, or both, where the status is based on the first priority level, the second priority level or both, and where the second operation includes a second write operation, a second read operation, or both.

Some examples of the method, apparatuses, and non-transitory computer-readable medium described herein may further include operations, features, means, or instructions for receiving, from the passive device, a second message including an indicator associated with a second querying device and a request to stop an operation to be performed at the passive device that was initiated by the second querying device and transmitting, to the second querying device based on the second message, a third message indicating the request for the second querying device to stop the operation initiated by the second querying device.

Some examples of the method, apparatuses, and non-transitory computer-readable medium described herein may further include operations, features, means, or instructions for transmitting the first priority level via the first query, where receiving the message may be based on the first priority level.

In some examples of the method, apparatuses, and non-transitory computer-readable medium described herein, where the first priority level may be based on the first operation including the first write operation or the first read operation, and where the second priority level may be based on the second operation including the second write operation or the second read operation and where the first priority level may be based on a first operation type associated with the first operation, and where the second priority level may be based on a second operation type associated with the second operation.

Some examples of the method, apparatuses, and non-transitory computer-readable medium described herein may further include operations, features, means, or instructions for transmitting, to the passive device, control signaling indicating a priority configuration usable for determining priority levels associated with operations to be performed at the passive device, where receiving the message may be based on the priority configuration.

Some examples of the method, apparatuses, and non-transitory computer-readable medium described herein may further include operations, features, means, or instructions for receiving the message from the passive device based on the first priority level being less than the second priority level, where the message includes an indication that the second operation may have a higher priority than the first operation.

Some examples of the method, apparatuses, and non-transitory computer-readable medium described herein may further include operations, features, means, or instructions for receiving the message from the passive device based on the first priority level being less than the second priority level, where the message includes an indication that the second operation may have a higher priority than the first operation, where the second operation may be associated with a second querying device.

Some examples of the method, apparatuses, and non-transitory computer-readable medium described herein may further include operations, features, means, or instructions for transmitting, to the passive device and in response to the message, a request for an identifier associated with the second querying device, receiving a second message from the passive device based on transmitting the request, the second message indicating the identifier associated with the second querying device, and transmitting a third message to the second querying device based on receiving the second message, the third message including a second request for the second querying device to stop the second operation.

Some examples of the method, apparatuses, and non-transitory computer-readable medium described herein may further include operations, features, means, or instructions for transmitting, to the passive device, a second query associated with the second operation, where the second query includes an instruction for the passive device to stop the first operation and to perform the second operation.

### BRIEF DESCRIPTION OF THE DRAWINGS

FIG. 1 illustrates an example of a wireless communications system that supports techniques for prioritizing and handling conflicting read and write commands for passive devices in accordance with one or more aspects of the present disclosure.

FIG. 2 illustrates an example of a wireless communications system that supports techniques for prioritizing and handling conflicting read and write commands for passive devices in accordance with one or more aspects of the present disclosure.

FIG. 3 illustrates an example of a resource configuration that supports techniques for prioritizing and handling conflicting read and write commands for passive devices in accordance with one or more aspects of the present disclosure.

FIG. 4 illustrates an example of a process flow that supports techniques for prioritizing and handling conflicting read and write commands for passive devices in accordance with one or more aspects of the present disclosure.

FIG. 5 illustrates an example of a process flow that supports techniques for prioritizing and handling conflicting read and write commands for passive devices in accordance with one or more aspects of the present disclosure.

FIG. 6 illustrates an example of a resource configuration that supports techniques for prioritizing and handling conflicting read and write commands for passive devices in accordance with one or more aspects of the present disclosure.

FIG. 7 illustrates an example of a process flow that supports techniques for prioritizing and handling conflicting read and write commands for passive devices in accordance with one or more aspects of the present disclosure.

FIG. 8 illustrates an example of a process flow that supports techniques for prioritizing and handling conflicting read and write commands for passive devices in accordance with one or more aspects of the present disclosure.

FIGS. 9 and 10 show block diagrams of devices that support techniques for prioritizing and handling conflicting read and write commands for passive devices in accordance with one or more aspects of the present disclosure.

FIG. 11 shows a block diagram of a communications manager that supports techniques for prioritizing and handling conflicting read and write commands for passive devices in accordance with one or more aspects of the present disclosure.

FIG. 12 shows a diagram of a system including a device that supports techniques for prioritizing and handling conflicting read and write commands for passive devices in accordance with one or more aspects of the present disclosure.

FIGS. 13 and 14 show block diagrams of devices that support techniques for prioritizing and handling conflicting read and write commands for passive devices in accordance with one or more aspects of the present disclosure.

FIG. 15 shows a block diagram of a communications manager that supports techniques for prioritizing and handling conflicting read and write commands for passive devices in accordance with one or more aspects of the present disclosure.

FIG. 16 shows a diagram of a system including a device that supports techniques for prioritizing and handling conflicting read and write commands for passive devices in accordance with one or more aspects of the present disclosure.

FIGS. 17 through 20 show flowcharts illustrating methods that support techniques for prioritizing and handling conflicting read and write commands for passive devices in accordance with one or more aspects of the present disclosure.

### DETAILED DESCRIPTION

Some wireless communications systems may include passive devices, such as radio frequency identifier (RFID) tags, passive Internet-of-Things (IoT) devices, etc. to perform certain operations such as location tracking and identification. To communicate with a passive device, a querying device (e.g., a user equipment (UE), network entity) may transmit a signal or query to the passive device to instruct the passive device to perform a writing operation and/or a reading operation. A writing operation may include one-way signaling from the querying device to the passive device to configure or adjust parameters of the passive device. Comparatively, a reading operation may include two-way signaling between the querying device and the passive device in which the querying device transmits a query or message, and receives or “reads” some responsive signaling back from the passive device.

Passive devices (e.g., RFID tags, passive IoT devices, hybrid devices with passive and active components) may include relatively low-complexity devices with limited resources and processing power. As such, passive devices may only be able to perform a limited number of read or write operations at a time. Moreover, some current wireless communications systems do not provide any signaling or other mechanisms to resolve conflicting (e.g., overlapping) read and write operations at passive devices. As such, upon receiving multiple queries for performing reading and/or writing operations, it may be unclear which reading/writing operation a passive device is expected to perform.

Accordingly, aspects of the present disclosure are directed to signaling and other mechanisms used to determine and resolve relative priorities for writing and reading operations at passive devices. In particular, aspects of the present disclosure are directed to rules and conditions for determining relative priorities between writing and reading operations to be performed at passive devices, and signaling from passive devices used to indicate a status or relative priority of conflicting read/write operations. Moreover, techniques described herein support signaling between querying devices and passive devices, as well as signaling between multiple querying devices, which may be used to pre-empt operations that are to be performed at a passive device.

For example, a passive device may receive multiple queries for performing separate read or write operations, where the separate read or write operations are associated with different priorities. The queries may be received from the same or different querying devices. The priorities may be explicitly signaled via the queries, determined based on the type of operations to be performed (e.g., write operations may be prioritized over read operations), determined based on identifiers of the querying devices which transmitted the queries, or any combination thereof. In this example, the passive device may transmit a message to the querying device(s) which transmitted the queries to indicate the status of the scheduled read/write operations (e.g., indicate which operation will be performed), and may perform one of the operations in accordance with the respective priorities. In some implementations, the passive device may periodically transmit (e.g., broadcast) a status of the passive device indicating whether the passive device is busy performing operations, indicating relative priorities of the scheduled operations, etc.

Aspects of the disclosure are initially described in the context of wireless communications systems. Additional aspects of the disclosure are described in the context of example resource configurations and example process flows. Aspects of the disclosure are further illustrated by and described with reference to apparatus diagrams, system diagrams, and flowcharts that relate to techniques for prioritizing and handling conflicting read and write commands for passive devices.

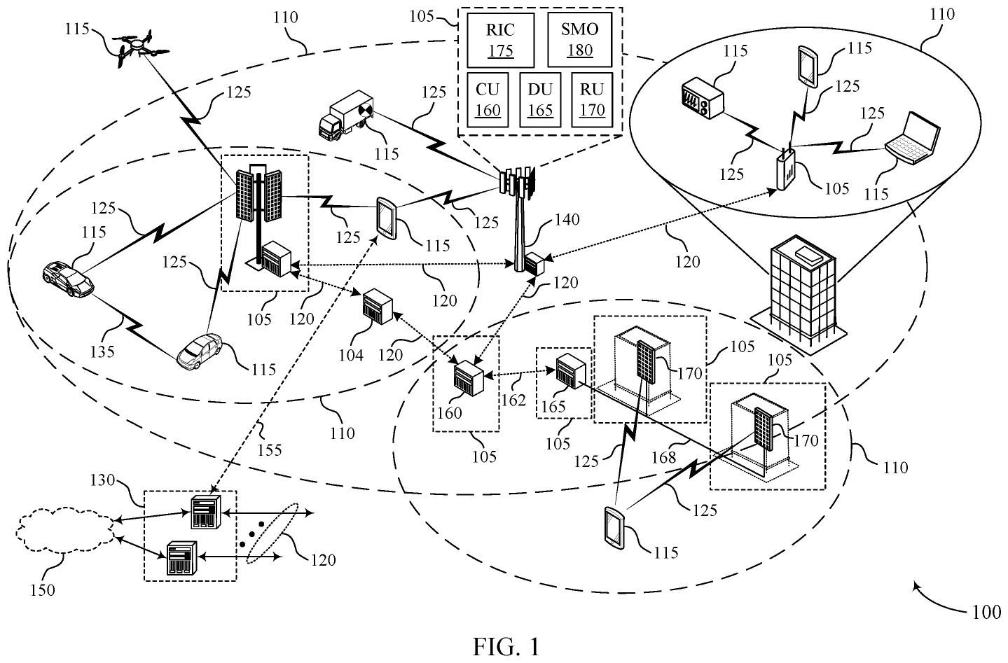

FIG. 1 illustrates an example of a wireless communications system 100 that supports techniques for prioritizing and handling conflicting read and write commands for passive devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the LAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for prioritizing and handling conflicting read and write commands for passive devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the wireless communications system 100 may include one or more passive devices. Passive devices may include, but are not limited to, RFID tags, passive IoT devices, hybrid devices including passive and active components, passive components of otherwise active/querying devices (e.g., passive components of a UE 115), or any combination thereof. For example, in some implementations, a UE 115 of the wireless communications system 100 may serve as a passive device.

In some aspects, the wireless communications system 100 may support signaling and other mechanisms used to determine and resolve relative priorities for writing and reading operations at passive devices. In particular, the wireless communications system 100 may support rules and conditions for determining relative priorities between writing and reading operations to be performed at passive devices, and signaling from passive devices used to indicate a status or relative priority of conflicting read/write operations. Moreover, the wireless communications system 100 may support signaling between passive and querying devices, as well as signaling between multiple querying devices, which may be used to pre-empt operations that are to be performed at a passive device.

For example, a passive device (e.g., RFID tag, passive IoT device, hybrid device including passive and active components, passive components of an otherwise active device such as a UE 115) of the wireless communications system 100 may receive multiple queries for performing separate read or write operations, where the separate read or write operations are associated with different priorities. The queries may be received from the same or different querying devices. For instance, the passive device may receive a first query for a first operation (e.g., first read or write operation) from a first UE 115, and a second query for a second operation (e.g., second read or write operation) from a second UE 115. Additionally, or alternatively, the passive device may receive separate queries for separate read or write operations from the same UE 115. The priorities associated with the operations to be performed at the passive device may be explicitly signaled via the queries, determined based on the type of operations to be performed (e.g., write operations may be prioritized over read operations), determined based on identifiers of the querying devices which transmitted the queries, or any combination thereof. In this example, the passive device may transmit a message to the querying device(s) (e.g., UEs 115) which transmitted the queries to indicate the status of the scheduled read/write operations (e.g., indicate which operation will be performed), and may perform one of the operations in accordance with the respective priorities.

In some implementations, the wireless communications system 100 may support signaling between devices that may be used to pre-empt performance of read/write operations at a passive device with higher-priority operations. For example, a querying device may transmit a query to a passive device for a read operation, and may subsequently transmit a separate query for the passive device to perform a higher-priority read operation, thereby pre-empting the original read operation. Similarly, techniques described herein may enable communications between querying devices (e.g., between UEs 115, between the network and UEs 115) which enables querying devices to request that other querying devices pause or suspend operations at passive devices to allow for the performance of higher-priority operations at the respective passive devices. Additionally, in some aspects, passive devices of the wireless communications system 100 may periodically transmit (e.g., broadcast) messages indicating whether the respective passive devices are busy performing operations, indicating relative priorities of read/write operations scheduled at the respective passive devices, and the like.

Techniques described herein may enable passive devices, such as RFID tags, passive IoT devices, etc., to determine relative priorities of read and write operations that are to be performed at the passive devices, thereby improving the speed and efficiency with which passive devices are able to perform reading and writing operations. As such, techniques described herein may improve the efficiency and latency of services and applications associated with passive devices within a wireless communications system, such as location tracking services. Moreover, techniques described herein may enable querying devices to quickly and efficiently determine a status of respective passive devices (e.g., whether each passive device is available or busy), thereby facilitating the ability of querying devices to identify passive devices that may be used for wireless communications.

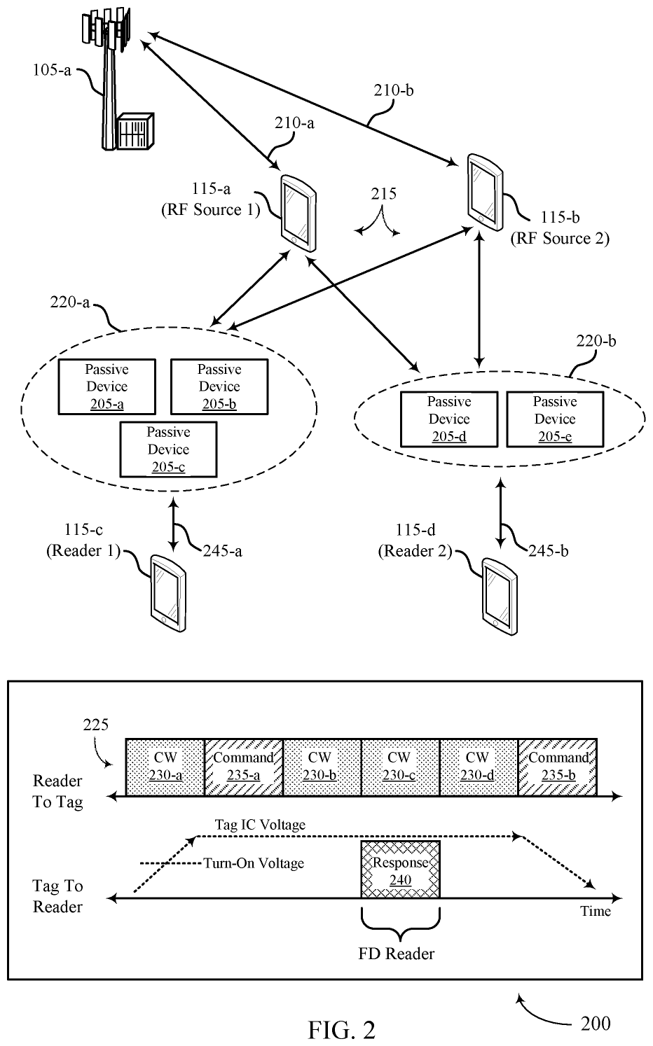

FIG. 2 illustrates an example of a wireless communications system 200 that supports techniques for prioritizing and handling conflicting read and write commands for passive devices in accordance with one or more aspects of the present disclosure. In some examples, aspects of the wireless communications system 200 may implement, or be implemented by, aspects of the wireless communications system 100. In particular, the wireless communications system 200 may support signaling, configurations, and other mechanisms which enable passive devices to determine a relative priority of read and write operations that are to be performed at the respective passive devices, as described with respect to FIG. 1.

The wireless communications system 200 may include a network entity 105-a, a first UE 115-a (e.g., first RF source, RF Source 1), a second UE 115-b (e.g., second RF source, RF Source 2), one or more passive devices 205, a third UE 115-c (e.g., first reader, Reader 1), and a fourth UE 115-d (e.g., second reader, Reader 2). In some aspects, the passive devices 205 (e.g., passive IoT devices) may include lower-complexity devices (e.g., <100 μW devices), such as RFID tags, passive IoT devices, hybrid devices including passive and active components, passive components of querying/active devices (e.g., passive components of a UE 115), and the like. For example, the passive devices 205 may include battery-less or limited energy storage (e.g., capacitor) devices capable of wireless communication.

As it is used herein, the term “passive device” may be used to refer to devices which may utilize passive signaling for performance of transmissions by the passive devices 205, actively powered radio signals for performance of transmissions by the passive devices 205, or both. In this regard, passive devices 205 may receive power for performance of transmissions from radio frequency signals received from other devices, from power sources associated with the passive devices 205, or both, as will be described in further detail herein. Moreover, as it is used herein, the terms “querying device,” “reader,” “RF source,” or any combination thereof, may refer to wireless devices (e.g., UEs 115, network entities 105, IAB nodes, etc.) that are configured to communicate with passive devices 205, such as by transmitting signals (e.g., queries, commands) to passive devices 205, receiving/reading signals from passive devices 205, and the like. As such,

The passive devices 205 may be used to support various services and applications within the wireless communications system 200, such as identification, tracking, the like. Other use cases that may be supported or facilitated by the passive devices 205 may include power sourcing, security applications, access control or access connectivity management, positioning services, and the like. Passive devices 205 may be capable of communicating over different frequency ranges, such as UHF ranges.

The UEs 115 may communicate with the network entity 105-a using communication links 210, which may be examples of NR or LTE links between the respective UEs 115 and the network entity 105-a. In some cases, the communication links 210 may include examples of access links (e.g., Uu links) which may include bi-directional links that enable both uplink and downlink communication. For example, the first UE 115-a may transmit uplink signals, such as uplink control signals or uplink data signals, to one or more components of the first network entity 105-a using the communication link 210-a, and one or more components of the first network entity 105-a may transmit downlink signals, such as downlink control signals or downlink data signals, to the first UE 115-a using the communication link 210-a. Similarly, the second UE 115-b and the network entity 105-a may communicate with one another using a communication link 210-b. Moreover, the third UE 115-c, the fourth UE 115-d, or both, may communicate with the network entity 105-a using communication links 210. Further, in some aspects, each of the UEs 115 may communicate with one another via communication links, such as sidelink communication links or PC5 links.

In some aspects, the one or more passive devices 205 may be grouped into sets 220 of passive devices 205. For example, as shown in FIG. 2, a first set 220-a of passive devices 205 may include a first passive device 205-a, a second passive device 205-b, and a third passive device 205-c, and a second set 220-b of passive devices 205 may include a fourth passive device 205-d and a fifth passive device 205-e. Passive devices 205 may be grouped into sets 220 of passive devices based on types of passive devices, capabilities, geographical location, type of service/application supported, etc. In some aspects, the first UE 115-a, the second UE 115-b, or both, may communicate with the passive devices 205 via communication links 215. Communication links 215 may be examples of PC5 links, Uu links, etc. Similarly, the third UE 115-c and the fourth UE 115-d may communicate with the passive devices 205 via communication links 245-a and 245-b, respectively, where the communication links 245 may be examples of PC5 or Uu links.

In some aspects, the respective wireless devices of the wireless communications system 200 (e.g., network entity 105-a, UEs 115, passive devices 205) may communicate with one another via energy harvesting and backscatter communication. For example, the passive devices 205 may support Energy Harvesting Enabled Communication Services (EHECS) in 5GS. The terms “forward communication” and “backscatter communication” may refer to a relative direction of communication between a querying device and a passive device 205. For example, in the context of backscatter communication, the first UE 115-a (e.g., querying device) may transmit a signal or query to the first passive device 205-a via a forward link of a communication link 215, and the first passive device 205-a may transmit a backscattered message via a backscatter link of the communication link 215.

For the purposes of the present disclosure, the terms “querying device,” “active device,” and like terms, may be used interchangeably to refer to wireless devices that are configured to transmit commands or queries to passive devices. Moreover, the terms “querying device,” “active device,” and like terms, may broadly be used to refer to wireless devices which transmit and/or receive signals from passive devices 205, and may therefore include “RF sources” and “Readers,” or both. In this regard, querying devices may include UEs 115, network entities 105, IAB nodes, and the like.

As noted previously herein, in some implementations, passive devices 205 may include relatively low-complexity devices which may or may not include a power amplifier and/or a battery. In some cases, passive devices 205 may include antennas (e.g., dipole antennas) and other circuitry (e.g., integrated circuit, chip, load) used to facilitate wireless communications. In some aspects, the range over which a passive device 205 can transmit a message (e.g., backscattered signal) may depend on the manner in which the respective passive device 205 is powered. For example, in some cases, a passive device 205 may not include a power source, but may instead receive power from wireless communications received from querying devices and may transmit far-field signals or modulate reflected signals using power absorbed or extracted from signals received from querying devices. In such cases, the range of such passive devices 205 may be limited to less than ten meters.

In some aspects, passive devices 205 may receive or generate power used for wireless communications and other operations using a rectifier, where a rectifier may include a diode and a capacitor. For example, a passive device 205 may receive a signal from a querying device (e.g., UE 115, network entity 105-a) via an antenna, where power absorbed from the antenna is directed to a power rectifier. In this example, the power rectifier converts absorbed power from the antenna to rectified power, which may be directed back to the antenna to transmit messages (e.g., transmit backscattered signals). In some cases, a power rectifier may exhibit an energy conservation efficiency of approximately thirty percent.

Power absorbed via an antenna of a passive device 205 may be directed from the antenna through an amplitude-shift keying (ASK) or phase-shift keying (PSK) modulator to the power rectifier. In order to perform signal modulation within a passive device 205, an ASK modulator may exhibit two different states. In a first state (e.g., matched load state), an integrated circuit or antenna resistance of the ASK modulator matches backscatter power (e.g., radiation power matches or equals power absorbed by the integrated circuit). Comparatively, in a second state (e.g., unmated load state, or open circuit state), the integrated circuit or antenna resistance of the ASK modulator does not match the backscatter power. The modulation efficiency of an ASK modulator may be defined by Modulation Efficiency=Practical/Idealized Radiation Power.

The querying devices (e.g., UEs 115, network entity 105-a) and passive devices 205 may communicate with one another by exchanging unmodulated and modulated signals or waves (e.g., commands). In particular, a querying device may transmit a continuous wave (CW) signal to a passive device 205 to power up the respective passive device 205, and may transmit modulated commands or packets to instruct the passive device 205 to perform write operations, read operations, or both. Moreover, the passive device 205 may convert absorbed power from CW signals (e.g., power absorbed from unmodulated signals) to transmit a modulated wave or message as a response to a received command.

For example, FIG. 2 illustrates an interrogator (e.g., reader)-talks-first (ITF) communication procedure between a querying device (e.g., RF source, reader, interrogator) and a passive device 205. For instance, the first UE 115-a may transmit a signal 225 to the first passive device 205-a. The signal 225 may include CW portions 230 and commands 235. A first CW portion 230-a may cause the first passive device 205-a to power up (e.g., turn on the passive device 205-a). The first CW portion 230-a may span more than 400 μs. As shown in FIG. 2, the first CW portion 230-a (e.g., unmodulated portion of signal 225) may cause a voltage of an integrated circuit of the passive device 205-a (e.g., tag) to increase above a turn-on voltage. Subsequently, the signal 225 may include a command 235-a (≥−20 dBm) that provides information and power to the first passive device 205-a. For example, the command 235-a may instruct the first passive device 205-a to perform a read operation, a write operation, or both. The signal may include a second CW portion 230-b (≥−20 dBm) to maintain a “turn-on” or active state of the first passive device 205-a.

Continuing with reference to the signal 225 illustrated in FIG. 2, a third CW portion 230-c (≥−20 dBm) may provide power and a carrier wave for signal modulation to be performed by the first passive device 205-a. For example, in the context of a read operation to be performed by the first passive device 205-a, the first passive device 205-a may utilize the third CW portion 230-c to transmit a response 240 (e.g., backscattered signal) to the third UE 115-c, where the third UE 115-c may perform full-duplex reading for the response 240. The signal may include a fourth CW portion 230-d (≥−20 dBm) to maintain a “turn-on” or active state of the first passive device 205-a, and a command 235-b (≥−20 dBm) that provides information and power to the first passive device 205-a, as described herein. Subsequently, following the end of the signal 225, the voltage of the first passive device 205-a may decrease below the turn-on voltage, and the first passive device 205-a may return to an inactive state.

While FIG. 2 is shown and described as including RF source devices (e.g., UEs 115-a, 115-b) and separate reader devices (e.g., UEs 115-c, 115-d), this is only for illustrative purposes, and is not to be regarded as a limitation of the present disclosure, unless noted otherwise herein. For example, in some cases, the first UE 115-a may serve as an RF source (e.g., power source) that provides a signal/power to a passive device 205, as well as an interrogator/reader that receives (e.g., “reads”) a backscattered signal or response 240 transmitted by a passive device 205. In other words, in some implementations, the first UE 115-a may serve as both the RF Source 1 and the Reader 1.

The passive devices 205 of the wireless communications system 200 may be configured to perform various types of operations, including writing operations and reading operations. A writing operation may include one-way signaling from a querying device (e.g., UE 115-a, 115-b) to a passive device 205 to configure or adjust parameters of the passive device 205. For example, writing operations may be used to change some information at a passive device 205 or adjust parameters or characteristics at a passive device 205, such as an identifier associated with the passive device 205, a type or frequency of measurements performed by the passive device 205.

Comparatively, a reading operation may include two-way signaling between a querying device and a passive device 205 in which the querying device transmits a query or message, and receives or “reads” some responsive signaling back from the passive device 205. For example, in the context of a reading operation, the first UE 115-a may transmit a query to a passive device 205 to request some information from the passive device 205, and the passive device 205 may return information or data in response (e.g., response 240, backscattered signal) to the query, such as data, a type of control information, measurements performed by the passive device 205, a location of the passive device 205, sensed information, or any combination thereof.

The response 240 from the passive device(s) 205 may include any type of data or information, and may depend on the type of passive device 205. Types of data/information that may be included within the response 240 from the passive device(s) 205 may include, but is not limited to, position information associated with the respective passive device 205 (e.g., current position), sensing/metering/measurement information collected or acquired by the passive device 205, expiry information (e.g., expiry date) of an item or product associated with the passive device 205 (e.g., a passive device 205 associated with a load of grain may indicate expiry information associated with the grain), a type of item or product associated with the passive device 205, a color of the item or product associated with the passive device 205, a data buffer size for data to be sent from the passive device 205 (e.g., passive device 205 may indicate how much data it has to send), a memory size of the passive device 205, tag information, and the like.

For example, in some cases, a passive device 205 may be configured to perform health-related measurements for a user or patient, including heart beat measurements, blood pressure measurements, temperature measurements, blood oxygenation measurements, and the like. In this example, the response 240 may indicate measurements performed by the passive device 205, changes in measurements performed by the passive device 205 (e.g., rate of change), alerts when measurements satisfy pre-defined thresholds, and the like.

However, as noted previously herein, passive devices 205 such as RFID tags, passive IoT devices, etc., may include relatively low-complexity devices with limited resources and processing power. As such, passive devices 205 may be able to perform a limited number of read or write operations at a time. For example, some passive devices 205 may be able to perform a single write operation or a single read operation at any given time. As such, in some wireless communications systems, it may be unclear which operation a passive device 205 is to perform when the respective passive device receives queries or commands to perform different operations. In other words, some wireless communications systems do not provide any signaling or other mechanisms to resolve conflicting (e.g., overlapping) read and write operations at passive devices 205. As such, upon receiving multiple queries for performing reading and/or writing operations, it may be unclear which reading/writing operation a passive device 205 is expected to perform.

Accordingly, aspects of the present disclosure are directed to signaling and other mechanisms used to determine and resolve relative priorities for writing and reading operations at passive devices 205. In particular, aspects of the present disclosure are directed to rules and conditions for determining relative priorities between writing and reading operations to be performed at passive devices 205, and signaling from passive devices 205 used to indicate a status or relative priority of conflicting read/write operations. Moreover, techniques described herein support signaling between passive devices 205 and querying devices, as well as signaling between multiple querying devices, which may be used to pre-empt operations that are to be performed at a passive device 205.

In some implementations, as will be described in further detail herein, passive devices 205 may be configured to prioritize operations (e.g., read operations, write operations) with higher priority levels over operations with lower priority levels. That is, passive devices 205 may be configured to perform higher-priority operations prior to lower-priority operations. Relative priorities of read and write commands may be determined or signaled in accordance with a number of implementations. In particular, read and write commands may be explicitly signaled, determined based on relative priorities between types of read and write commands, determined based on priorities of querying devices initiating the respective read/write operations, determined based on a satisfaction of one or more conditions, or any combination thereof.

For example, in some cases, querying devices (e.g., UEs 115, network entity 105-a) may transmit messages or queries initiating read commands, write commands, or both, where the commands/queries indicate a priority level associated with the respective operation. In other words, when writing and/or sending data to passive devices 205 (e.g., RFID tags, passive IoT devices, hybrid devices including passive and active components), each command/query or set of commands may be associated with a respective priority level, which may be explicitly or implicitly indicated via the command/query. Moreover, when reading from passive devices 205, each data query read from a passive device 205 may be associated with a respective priority level. For example, referring to FIG. 2, the commands 235-a, 235-b may initiate read operations, write operations, or both, that are to be performed by a passive device 205, where the commands 235-a, 235-b indicate priority levels associated with the respective operations initiated by the commands 235.

In some cases, reading and writing operations may be associated with differing priority levels. For example, in some cases, writing operations may be associated with higher priority levels as compared to reading operations. Writing operations may be given higher priority levels as writing operations used to configure/adjust system parameters at a passive device 205 that will be used for subsequent reading operations. Comparatively, in other implementations, reading operations may be associated with higher priority levels as compared to writing operations.

In some aspects, priority levels associated with reading and writing operations may vary based on the type of operation to be performed (e.g., type of data to be read or written). For example, Type A reading and/or writing operations may be associated with higher priority levels as compared to Type B reading and/or writing operations. In such cases, commands/queries for read/write operations may indicate the type of operation that is to be performed (e.g., Type A, Type B, . . . , Type n), where the passive devices 205 may be configured to determine relative priority levels of the operations based on the corresponding types of operations. Types of operations may be based on a number of factors, including the type of data to be read/written by the respective operations, a service/application supported by the respective operation, etc.

In some aspects, priority levels associated with operations to be performed at the passive devices 205 may be based on a type of data that is to be processed/returned by the passive device 205 (e.g., operations associated with positioning data may have higher priority levels compared to operations associated with data size on RFID buffer or meta data). Additionally, or alternatively, priority levels associated with operations to be performed at the passive devices 205 may be based on respective applications associated with the operations/measurements to be performed by the passive device 205 (e.g., medical tags performing sensing measurements for patients and may be associated with higher priority levels than other types of operations used for other applications or other contexts).

In some implementations, a priority level for a given operation (e.g., operation priority, or session priority) may be based on a highest priority level of the associated data (e.g., data type) that is to be processed, retrieved, or returned during the operation/session. For example, the first passive device 205-a may be commanded or queried to perform an operation (e.g., session) that includes reading or writing data of type A, type B, and type C (e.g., commands/information of types A, B, and C), where data type A, data type B, and data type C are associated with different priority levels. In this example, the priority level of the operation/session may include the highest priority level associated with data types A, B, and C. In other words, the highest priority level of data type A, B, or C may determine the operation priority level (session priority level).

In additional or alternative implementations, operation/session priority levels may be determined independently of priority levels associated with data types. In other words, operations may be associated with a first granularity of priority levels, where data types/information to be performed/returned during the respective operations may be associated with a second granularity of priority levels of QoS parameters. For instance, continuing with the example above, the first passive device 205-a may be commanded or queried to perform an operation (e.g., session) that includes reading or writing data of type A, type B, and type C, where data type A has a higher priority than data types B and C, and data type B has a higher priority than data type C (e.g., A priority>B priority>C priority). In this example, upon determining to prioritize the operation, the first passive device 205-a may then perform/retrieve the data types in accordance with the priority levels of the respective data types. As such, the first passive device 205-a may read or write data type A first, then read/write data type B, then read/write data type C.

In some aspects, priority levels associated with operations and/or data types to be read/written may be based on other parameters, such as QoS metrics, physical requirements associated with reliability (e.g., a read or write operation is expected to be performed with a certain error rate, BLER requirement, etc.), delay requirements, and the like. For example, higher QOS metrics may be associated with higher priority levels compared to lower QoS metrics. Similarly, operations with lower error rates or lower delay requirements may be associated with higher priority levels as compared to operations with higher error rates or higher delay requirements.

In additional or alternative implementations, priority levels associated with operations to be performed by a passive device 205 (e.g., read operations, write operations) may be determined based on the querying devices which requested the respective operations to be performed. In this regard, passive devices 205 may determine relative priorities of read/write operations based on identifiers associated with querying devices from which commands/queries are received. For example, operations initiated by the first UE 115-a may be prioritized over (e.g., performed prior to) operations initiated by the second UE 115-b. In other words, read/write operations initiated by the first UE 115-a may be associated with higher priorities as compared to operations imitated by the second UE 115-b. In this regard, commands/queries transmitted by querying devices to initiate operations at passive devices 205 may include identifiers associated with the respective querying devices to enable the passive devices 205 to determine relative priority levels of the initiated operations.

In some cases, passive devices 205 (e.g., RFID tags, passive IoT devices, hybrid devices including passive and active components) may be configured by a controlling unit (e.g., network entity 105-a, base station, gNB) to follow orders, commands, and queries of certain querying devices (e.g., RF sources, readers, interrogators) over other wireless devices. For example, in some cases, the network entity 105-a may transmit control signaling to the passive devices 205, where the control signaling instructs the passive devices 205 to prioritize operations initiated by the first UE 115-a over operations initiated by the second UE 115-b.

Similarly, in some cases, passive devices 205 may be configured with one or more priority configurations which are used to determine relative priorities between different operations, or relative priorities between commands/queries received from querying devices. As it is used herein, the term “priority configurations” may be used to refer to a set of rules, conditions, or other parameters that are used to determine priority levels of operations/queries, and to resolve conflicts between operations. For example, the first passive device 205-a may receive control signaling (e.g., a query or command for a write operation) from the network entity 105-a, the first UE 115-a, or both, where the control signaling indicates a priority configuration usable by the first passive device 205-a for determining priority levels of read and write operations that are to be performed by the first passive device 205-a. In this example, the priority configuration may include conditions or rules for determining priority levels associated with operations and/or queries/commands.

For instance, the priority configuration may cause the first passive device 205-a to assign or determine higher priority levels associated with write operations as compared to read operations. By way of another example, the priority configuration may cause the first passive device 205-a to assign or determine a higher priority level associated with a first operation initiated by the first UE 115-a as compared to a second operation initiated by the second UE 115-b where the first and second operations are associated with the same operation type. Moreover, the priority configuration may cause the first passive device 205-a to assign or determine higher priority levels associated with operations initiated by the first UE 115-a unless an operation initiated by the second UE 115-b is associated with an operation type with a higher priority level (e.g., prioritize Type A operations initiated by second UE 115-b over Type B operations initiated by first UE 115-a).

In some aspects, techniques described herein may enable querying devices to override or pre-empt operations initiated at passive devices 205 with other, higher-priority operations. For example, a querying device (e.g., UE 115, network entity 105, gNB, control unit programmable logic controllers (PLCs) in sidelink) may communicate a message to an RF source (or a reader), where the message indicates whether to cancel reading from a passive device 205 or not, or whether to write/read some other information with a different priority level or operation type.

Stated differently, a querying device (e.g., UE 115) may initiate a read/write operation at a passive device 205, and may subsequently override, cancel, or pre-empt the previously-initiated operation with a different (e.g., higher-priority) operation (e.g., the same querying device sends a query/command to an RFID tag for an operation with a higher priority level than a previously initiated operation). Moreover, a first querying device (e.g., first UE 115-a) may initiate a read/write operation at a passive device 205, and a second querying device (e.g., second UE 115-b) may override or pre-empt the initial operation with a different, higher-priority operation. Pre-emption of reading/writing operations at a passive device 205 may be triggered where a new read operation of some type of data can cancel an old read operation with a different (e.g., lower) priority level.

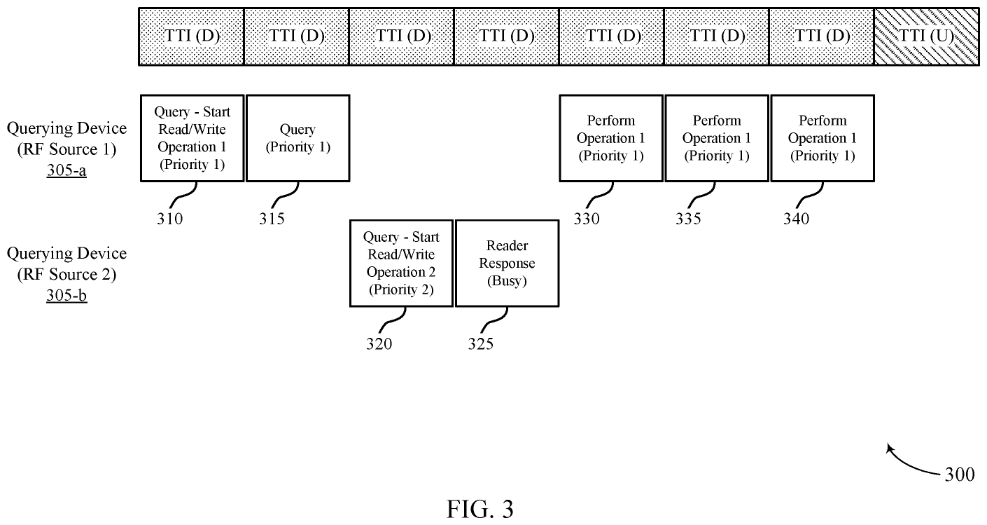

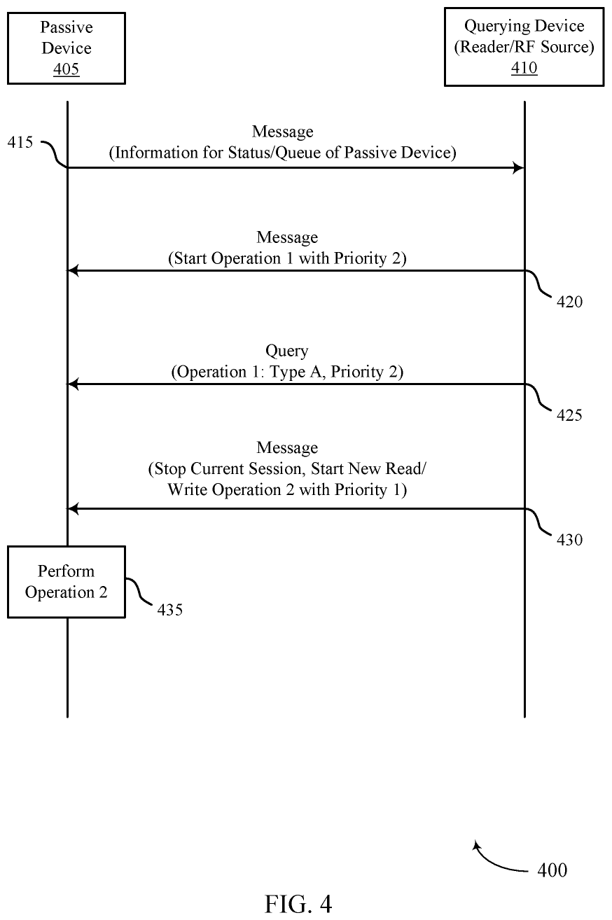

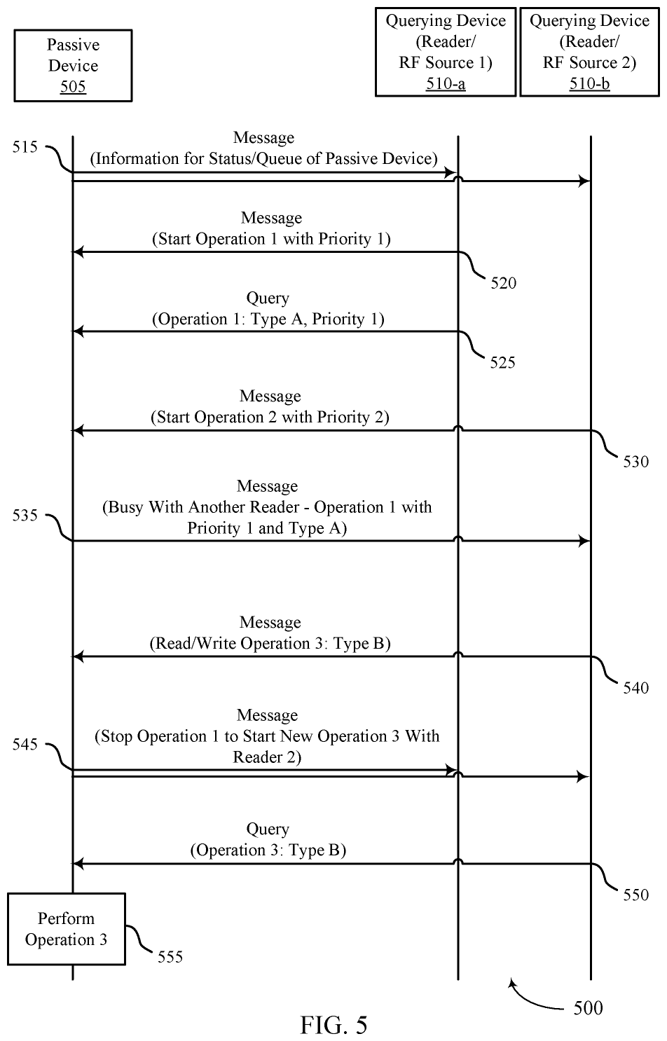

Pre-emption of read/write operations by a same querying device will be shown and described in further detail with respect to FIGS. 3 and 4. Moreover, pre-emption of read/write operations by different querying devices will be shown and described in further detail with respect to FIGS. 3 and 5.

Moreover, in order to facilitate timely and efficient performance of higher-priority operations to be performed at the passive devices 205, the respective wireless devices (e.g., passive devices 205, UEs 115, network entity 105-a) may be configured to exchange information regarding initiated operations with one another in order to coordinate or negotiate which operations will be prioritized/performed at the respective passive devices 205. In particular, querying devices may be configured to request (from passive devices) identifiers associated with other querying devices so that the querying devices can coordinate and/or negotiate with one another regarding which operations will be performed and/or prioritized at the passive device 205.

For example, the first UE 115-a may transmit a query to the first passive device 205-a for a read or write operation to be performed at the first passive device 205-a, and the first passive device 205-a may respond with a message indicating that the first passive device 205-a is busy with another, higher-priority operation. In this example, the first UE 115-a may transmit a request to the first passive device 205-a for an identifier of the querying device which initiated the other higher-priority operation. Continuing with the same example, upon receiving the request, the first passive device 205-a may transmit a response message that indicates the second UE 115-b is the querying device that initiated the other, higher-priority operation. Subsequently, upon receiving the identifier of the second UE 115-b, the first UE 115-a may communicate with the second UE 115-b to coordinate or negotiate which operation will be prioritized/performed at the first passive device 205-a. For instance, the first UE 115-a may request information associated with a priority level for the operation initiated by the second UE 115-b, indicate a priority level of the operation that is to be initiated by the first UE 115-a, request that the second UE 115-b stop or postpone the operation previously initiated by the second UE 115-b, or any combination thereof.

In additional or alternative implementations, information indicating querying devices which have initiated operations at passive devices may be communicated through a control unit (e.g., PLC in sidelink), or other centralized unit, such as the network entity 105-a. For example, the first UE 115-a may transmit a query to the first passive device 205-a for a read or write operation to be performed at the first passive device 205-a, and the first passive device 205-a may respond with a message indicating that the first passive device 205-a is busy with another, higher-priority operation. In this example, the first UE 115-a may transmit a request to the first passive device 205-a for an identifier of the querying device which initiated the other higher-priority operation. Continuing with the same example, upon receiving the request, the first passive device 205-a may transmit a response message to the network entity 105-a, where the response message indicates the second UE 115-b is the querying device that initiated the other, higher-priority operation. The response message may additionally indicate priority levels of the respective operations initiated by the first UE 115-a and the second UE 115-b. In this example, the network entity 105-a may relay the response message to the first UE 115-a and/or transmit a message to the second UE 115-b requesting that the second UE 115-b stop or postpone the operation previously initiated by the second UE 115-b. In this regard, in some implementations, the network entity 105-a (or other control/centralized unit) may receive information associated with different operations to be performed at a passive device 205, and may coordinate or otherwise determine which operations should be given higher priority, and may instruct querying devices to stop, postpone, or re-initiate operations accordingly.

In some aspects, passive devices 205 of the wireless communications system 200 may be configured to backscatter signals to querying devices (e.g., UEs 115, network entity 105), where the backscattered signals indicate a status of the respective passive devices 205. That is, a passive device 205 may transmit or broadcast messages indicating whether the respective passive device 205 is booked, whether the passive device 205 is being read by another querying device (e.g., another RF source/reader), and the like. In this regard, passive devices 205 may transmit or broadcast messages associated with a queue of operations to be performed by the respective passive devices 205 to inform querying devices as to whether or not the respective passive devices 205 are busy or not (e.g., whether they are booked or not).

For the purposes of the present disclosure, the term “status message” may be used to refer to signals or messages transmitted/broadcast by passive devices 205 which indicate whether the respective passive devices 205 are busy/booked or not. In other words, status messages may communicate information associated with the status of the passive device 205 (e.g., whether the passive device 205 is available or busy/booked), information associated with a queue of operations to be performed by the passive device 205, and the like. Status messages may indicate a quantity of operations in a queue of operations that are to be performed by the passive device 205, types of operations in the queue, priority levels of operations in the queue, identifiers of querying devices that initiated the operations (e.g., ID of RF source, ID of reader), whether the respective operations in the queue have the same device for an RF source/reader or different devices for the RF source and reader, or any combination thereof.

In some cases, status messages indicating a status or queue of a passive device 205 may be transmitted periodically, aperiodically, etc. For example, the first passive device 205-a may transmit status messages associated with a queue of operations to be performed by the first passive device 205-a according to aperiodicity. In this example, the periodicity may be pre-configured at the first passive device 205-a, signaled to the first passive device 205-a (e.g., via a write query/command), or both.

The mechanism in which passive devices 205 transmit status messages associated with a status/queue of the respective passive devices 205 may be based on whether or not the respective passive device 205 includes a separate power source. In particular, passive devices 205 that include a separate power source may be able to transmit status messages associated with a status/queue of operations on their own (e.g., without receiving signals/power from a querying device). In other words, in this example, the first passive device 205-a may include a power source and/or an active or semi-active RF component that is capable of transmitting signals and generating waveforms independently (without backscattering). Comparatively, passive devices 205 that that do not include a separate power source may receive signals/power from querying devices (e.g., UEs 115, network entity 105-a, centralized unit, RF emitter) to enable the passive devices 205 to transmit status messages.

For example, in cases where the first passive device 205-a includes a power source, the first passive device 205-a may autonomously transmit/broadcast status messages associated with a status/queue of the first passive device 205-a to inform neighboring querying devices as to the availability of the first passive device 205-a. By way of another example, the second passive device 205-b may not include a power source. In this example, the first UE 115-a and/or the second UE 115-b (RF Sources) may transmit RF source signals periodically or aperiodically to provide the second passive device 205-b with power that may be used to transmit (e.g., backscatter) status messages associated with a status/queue of the second passive device 205-b.

Techniques described herein may enable passive devices 205, such as RFID tags, to determine relative priorities of read and write operations that are to be performed at the passive devices 205, thereby improving the speed and efficiency with which passive devices 205 are able to perform reading and writing operations. As such, techniques described herein may improve the efficiency and latency of services and applications associated with passive devices 205 within the wireless communications system 200, such as location tracking services. Moreover, techniques described herein may enable querying devices (e.g., UEs 115, network entity 105-a) to quickly and efficiently determine a status of respective passive devices 205 (e.g., whether each passive device 205 is available or busy), thereby facilitating the ability of querying devices to identify passive devices 205 that may be used for wireless communications.

FIG. 3 illustrates an example of a resource configuration 300 that supports techniques for prioritizing and handling conflicting read and write commands for passive devices in accordance with one or more aspects of the present disclosure. In some examples, aspects of the resource configuration 300 may implement, or be implemented by, aspects of the wireless communications system 100, the wireless communications system 200, or both. In particular, the resource configuration 300 illustrates signaling between a passive device and RF sources that enables the passive device to determine and signal a relative priority between read and write operations, as described with reference to FIGS. 1-2, among other aspects.

The resource configuration 300 illustrates communications between a passive device (e.g., passive device 205 illustrated in FIG. 2) and one or more querying devices 305 within a set of transmission time intervals (TTIs) (e.g., slots, sets of slots). In particular, the resource configuration 300 illustrates communications between a first querying device 305-a, a second querying device 305-b, and a passive device.

At 310, the first querying device 305-a may transmit a query or command to start or initiate a first operation (e.g., first read operation, first write operation) at the passive device, where the first operation is associated with a first priority level (Priority 1). For example, the first querying device 305-a may transmit a CW portion 230 of a query to power-up the passive device, as shown in FIG. 2. As described previously herein, the priority level of the first operation may be explicitly or implicitly signaled via the query at 310, and/or determined based on the type of operation, a priority or identifier associated with the first querying device 305-a, based on a priority configuration, or any combination thereof. At 315, the first querying device 305-a transmits a query or command for the first operation. For example, the first querying device may transmit a command 235-a for the first operation, as shown in FIG. 2.

At 320, the second querying device 305-b may transmit a query or command to start or initiate a second operation (e.g., second read operation, second write operation) at the passive device, where the second operation is associated with a second priority level (Priority 2) that is less than the first priority level (e.g., Priority 2<Priority 1). For example, the second querying device 305-b may transmit a CW portion 230 of a query to power-up the passive device, as shown in FIG. 2. As described previously herein, the priority level of the second operation may be explicitly or implicitly signaled via the query at 320, and/or determined based on the type of operation, a priority or identifier associated with the second querying device 305-b, based on a priority configuration, or any combination thereof.

At 325, the passive device may transmit a response message to the second querying device 305-b, where the response message indicates that the passive device is busy communicating with another reader/querying device for an operation/session with a higher priority. In other words, the passive device may indicate, to the second querying device 305-b, that the passive device is prioritizing the first operation initiated by the first querying device 305-a over the second operation initiated by the second querying device 305-b.

At 330, 335, 340, or any combination thereof, the passive device may perform the first operation. For example, in the context of a write operation, the passive device may configure or modify one or more operational parameters of the passive device. Comparatively, in the context of a reading operation, the passive device may transmit signals to the first querying device 305-a (or a related reader device), where the signals indicate measurements performed by the passive device, a location of the passive device, and the like.

The signaling and operations shown and described in FIG. 3 may be further understood with reference to FIGS. 4 and 5.

FIG. 4 illustrates an example of a process flow 400 that supports techniques for prioritizing and handling conflicting read and write commands for passive devices in accordance with one or more aspects of the present disclosure. In some examples, aspects of the process flow 400 may implement, or be implemented by, aspects of the wireless communications system 100, the wireless communications system 200, the resource configuration 300, or any combination thereof. In particular, the process flow 400 illustrates signaling between a querying device and a passive device that enables the querying device to pre-empt a previously initiated read/write operation with a higher-priority operation, as described with reference to FIGS. 1-3, among other aspects.

The process flow 400 may include a passive device 405 and a querying device 410, which may be examples of passive devices, UEs 115, network entities 105, and other wireless devices described with reference to FIGS. 1-3. For example, the passive device 405 may include an example of an RFID tag or a passive component of a querying device, as shown and described in FIG. 2. Similarly, the querying device 410 may include an example of the network entity 105-a, a UE 115, or both, as shown and described in FIG. 2.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 415, the passive device 405 may transmit or broadcast a message indicating information associated with a status or queue of operations to be performed at the passive device 405. In other words, the passive device 405 may transmit a message indicating whether the passive device 405 is available, or whether the passive device is booked/busy. In some cases, passive device 405 may transmit the message at 405 in accordance with some periodicity, where the periodicity may be pre-configured, signaled to the passive device 405 (e.g., via a write operation), or both. Moreover, in some cases, the passive device 405 may transmit the message at 415 based on receiving some RF signal (e.g., from the querying device 410 or other device, such as a network entity 105) that provides power for the passive device 405 to transmit the signal.

At 420, the querying device 410 may transmit, to the passive device 405, a signal or message to start a first operation (Operation 1) at the passive device 405. The first operation may include a read operation or a write operation that is to be performed by the passive device, where the first operation is associated with a second priority level (Priority 2). For example, the querying device 410 may transmit a CW portion 230 of a query to power-up the passive device, as shown in FIG. 2. As described previously herein, the priority level of the first operation may be explicitly or implicitly signaled via the message at 420, and/or determined based on the type of operation, a priority or identifier associated with the querying device 410, based on a priority configuration, or any combination thereof. In some aspects, the querying device 410 may transmit the message at 420 based on receiving the message associated with the status/queue of the passive device 405 at 415.

At 425, the querying device 410 may transmit a query or command for the first operation. For example, the querying device 410 may transmit a command 235-a for the first operation, as shown in FIG. 2. As such, the querying device 410 may transmit the query at 425 based on transmitting the message to initiate the first operation at 420. In some aspects, the query at 420 may indicate an operation type associated with the first operation, the priority level associated with the first operation, or both.

At 430, the querying device 410 may transmit a message (e.g., query, command) for the passive device 405 to perform a second operation (Operation 2) with a higher priority (Priority 1) as compared to the first operation (e.g., Priority 1>Priority 2). In other words, the querying device 410 may instruct the passive device to stop the current session (e.g., stop or refrain from performing the first operation) in order to start a new read/write operation (e.g., Operation 2). Accordingly, the querying device 410 may effectively pre-empt the original, first operation in lieu of the second operation with the higher priority.

In cases where the passive device 405 prioritizes the second operation over the first operation, the passive device 405 may add the first operation (Operation 1) to a queue of operations to be performed by the passive device 405. In this regard, Operation 1 may be stored in a queue or memory so that the passive device 405 may perform Operation 1 after Operation 2 is completed.

At 435, the passive device 405 may perform the second operation (Operation 2). For example, in the context of a write operation, the passive device 405 may configure or modify one or more operational parameters of the passive device 405. Comparatively, in the context of a reading operation, the passive device 405 may transmit signals to the querying device 410 (or a related reader device), where the signals indicate measurements performed by the passive device 405, a location of the passive device 405, and the like.

In cases where the passive device 405 prioritizes Operation 2 over Operation 1, the passive device 405 may add Operation 1 to a queue of operations to be performed by the passive device 405. In this regard, Operation 1 may be stored in a queue or memory so that the passive device 405 may perform Operation 1 after Operation 2 is completed.

Techniques described herein may enable querying devices to pre-empt or override previous operations initiated at the passive device 405. In particular, as shown in FIG. 4, techniques described herein may enable the querying device 410 to pre-empt another operation that was previously initiated at the passive device 405 by the querying device 410.

FIG. 5 illustrates an example of a process flow 500 that supports techniques for prioritizing and handling conflicting read and write commands for passive devices in accordance with one or more aspects of the present disclosure. In some examples, aspects of the process flow 500 may implement, or be implemented by, aspects of the wireless communications system 100, the wireless communications system 200, the resource configuration 300, or any combination thereof. In particular, the process flow 500 illustrates signaling between querying devices and a passive device that enables a querying device to pre-empt a read/write operation that was previously initiated by another querying device with a higher-priority operation, as described with reference to FIGS. 1-4, among other aspects.

The process flow 500 may include a passive device 505, a first querying device 510-a, and a second querying device 510-b, which may be examples of passive devices, UEs 115, network entities 105, and other wireless devices described with reference to FIGS. 1-4. For example, the passive device 505 may include an example of an RFID tag or a passive component of a querying device, as shown and described in FIG. 2. Additionally, the first querying device 510-a may include an example of the first UE 115-a, the third UE 115-c, or both, as shown and described in FIG. 2. Similarly, the second querying device 510-b may include an example of the second UE 115-b, the fourth UE 115-d, or both, as shown and described in FIG. 2.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 515, the passive device 505 may transmit or broadcast, to the first querying device 510-a, the second querying device 510-b, or both, a message indicating information associated with a status or queue of operations to be performed at the passive device 505. In other words, the passive device 505 may transmit a message indicating whether the passive device 505 is available, or whether the passive device is booked/busy. In some cases, passive device 405 may transmit the message at 505 in accordance with some periodicity, where the periodicity may be pre-configured, signaled to the passive device 505 (e.g., via a write operation), or both. Moreover, in some cases, the passive device 505 may transmit the message at 515 based on receiving some RF signal (e.g., from the first querying device 510-a, second querying device 510-b, or other device, such as a network entity 105) that provides power for the passive device 505 to transmit the signal.

At 520, the first querying device 510-a may transmit, to the passive device 505, a signal or message to start a first operation (Operation 1) at the passive device 505. The first operation may include a read operation or a write operation that is to be performed by the passive device 505, where the first operation is associated with a first priority level (Priority 1). For example, the first querying device 510-a may transmit a CW portion 230 of a query to power-up the passive device, as shown in FIG. 2. As described previously herein, the priority level of the first operation may be explicitly or implicitly signaled via the message at 520, and/or determined based on the type of operation, a priority or identifier associated with the first querying device 510-a, based on a priority configuration, or any combination thereof. In some aspects, the first querying device 510-a may transmit the message at 520 based on receiving the message associated with the status/queue of the passive device 505 at 515.

At 525, the first querying device 510-a may transmit a query or command for the first operation. For example, the first querying device 510-a may transmit a command 235-a for the first operation, as shown in FIG. 2. As such, the first querying device 510-a may transmit the query at 520 based on transmitting the message to initiate the first operation at 520, and/or receiving the message associated with the status/queue of the passive device 505 at 515. In some aspects, the query at 525 may indicate an operation type associated with the first operation (e.g., Type A), the priority level associated with the first operation, or both.

At 530, the second querying device 510-b may transmit a message (e.g., query, command) for the passive device 505 to perform a second operation (Operation 2) with a lower priority (Priority 2) as compared to the first operation (e.g., Priority 1>Priority 2). In other words, the second querying device 510-b may attempt to pre-empt the first operation at the passive device 505 by transmitting the query for the second operation. However, in some implementations, the passive device 505 may be configured to prioritize higher-priority operations over lower-priority operations, and may therefore prioritize Operation 1 over Operation 2 (e.g., perform Operation 1 prior to Operation 2). In some aspects, the second querying device 510-b may transmit the message at 530 based on receiving the message associated with the status/queue of the passive device 505 at 515.

At 535, the passive device 505 may transmit a response message to the second querying device 510-b, where the response message indicates that the passive device 505 is busy communicating with another reader/querying device for an operation/session with a higher priority. In other words, the passive device 505 may indicate, to the second querying device 510-b, that the passive device 505 is prioritizing Operation 1 initiated by the first querying device 510-a over Operation 2 initiated by the second querying device 510-b. In some implementations, the passive device 505 may transmit the response message to both the first and second querying devise 510 so that the querying devices 510 can predict or expect the behavior of the passive device 505.

In cases where the passive device 505 prioritizes Operation 1 over Operation 2, the passive device 505 may add Operation 2 to a queue of operations to be performed by the passive device 505. In this regard, Operation 2 may be stored in a queue or memory so that the passive device 505 may perform Operation 2 after Operation 1 is completed.

At 540, the second querying device 510-b may transmit a message (e.g., query, command) for the passive device 505 to perform a third operation (Operation 3). In some aspects, the third operation may be associated with an operation type (Type 3) that has a higher priority than other operation types. In other words, operations associated with Type B may have higher priority levels than operations associated with Type A. In this regard, Operation 3 may have a higher priority level as compared to both Operation 1 and Operation 1 (e.g., Priority_{Op 3}>Priority_{Ops 1 and 2}. Accordingly, the passive device 505 may be configured to prioritize Operation 3 over Operations 1 and 2. Thus, the second querying device 505-b may effectively pre-empt Operation 1 that was previously initiated by the first querying device 510-a.

At 545, the passive device 505 may transmit a message to the first querying device 510-a, where the message indicates that the passive device 505 will stop performing (or refrain from performing) the first operation due to the fact that the passive device 505 received a query for a higher-priority operation. In other words, the passive device 505 may indicate that Operation 1 has been pre-empted with a higher-priority operation. In some cases, the passive device 505 may additionally transmit the message at 545 to the second querying device 510-b to indicate that the passive device 505 will prioritize Operation 3.

In cases where the passive device 505 prioritizes Operation 3 over Operation 1 (and Operation 2), the passive device 505 may add Operation 1 to a queue of operations to be performed by the passive device 505. Moreover, Operation 1 may be added to the queue ahead of Operation 2 due to the fact that Operation 1 is associated with a higher priority compared to Operation 2. In this regard, Operation 1 may be stored in a queue or memory so that the passive device 505 may perform Operation 1 after Operation 2 is completed.

At 550, the second querying device 510-b may transmit a query or command for the third operation. For example, the second querying device 510-b may transmit a command 235-a for the first operation, as shown in FIG. 2. As such, the second querying device 510-b may transmit the query at 550 based on transmitting the message to initiate the third operation at 540, receiving the response message at 545, or both. In some aspects, the query at 545 may indicate an operation type associated with the third operation (e.g., Type b), the priority level associated with the third operation, or both.

At 555, the passive device 505 may perform the third operation (Operation 3). For example, in the context of a write operation, the passive device 505 may configure or modify one or more operational parameters of the passive device 505. Comparatively, in the context of a reading operation, the passive device 505 may transmit signals to the second querying device 510-b (or a related reader device), where the signals indicate measurements performed by the passive device 505, a location of the passive device 405, and the like.

Techniques described herein may enable querying devices 510 to pre-empt or override previous operations initiated at the passive device 505. In particular, as shown in FIG. 5, techniques described herein may enable the second querying device 510-b to pre-empt another operation that was previously initiated at the passive device 505 by the first querying device 510-a.

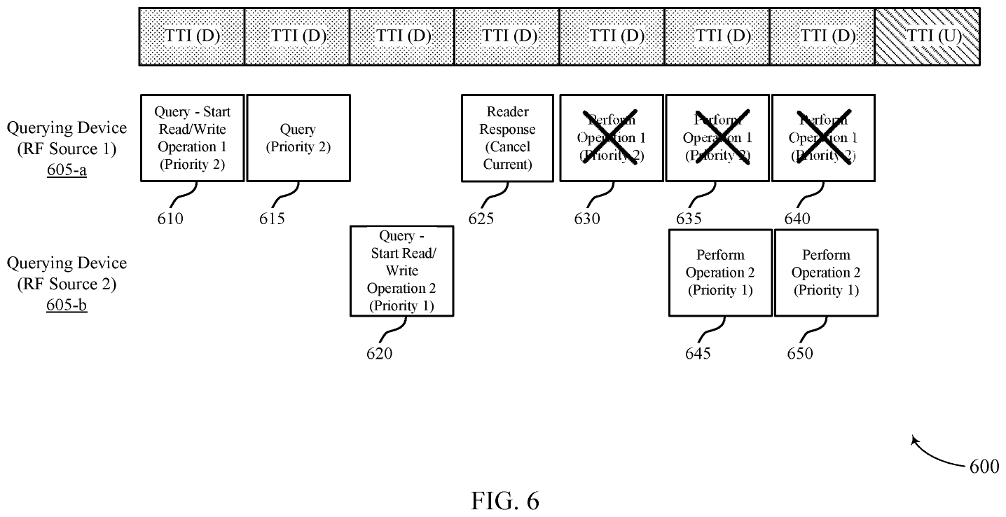

FIG. 6 illustrates an example of a resource configuration 600 that supports techniques for prioritizing and handling conflicting read and write commands for passive devices in accordance with one or more aspects of the present disclosure. In some examples, aspects of the resource configuration 600 may implement, or be implemented by, aspects of the wireless communications system 100, the wireless communications system 200, or both. In particular, the resource configuration 600 illustrates signaling between a passive device and RF sources that enables the passive device to determine and signal a relative priority between read and write operations, as described with reference to FIGS. 1-5, among other aspects.

The resource configuration 600 illustrates communications between a passive device (e.g., passive device 205 illustrated in FIG. 2) and one or more querying devices 605 within a set of TTIs (e.g., slots, sets of slots). In particular, the resource configuration 600 illustrates communications between a first querying device 605-a, a second querying device 605-b, and a passive device.

At 610, the first querying device 605-a may transmit a query or command to start or initiate a first operation (e.g., first read operation, first write operation) at the passive device, where the first operation is associated with a second priority level (Priority 2). For example, the first querying device 605-a may transmit a CW portion 230 of a query to power-up the passive device, as shown in FIG. 2. As described previously herein, the priority level of the first operation may be explicitly or implicitly signaled via the query at 610, and/or determined based on the type of operation, a priority or identifier associated with the first querying device 605-a, based on a priority configuration, or any combination thereof. At 615, the first querying device 605-a transmits a query or command for the first operation. For example, the first querying device may transmit a command 235-a for the first operation, as shown in FIG. 2.

At 620, the second querying device 605-a may transmit a query or command to start or initiate a second operation (e.g., second read operation, second write operation) at the passive device, where the second operation is associated with a first priority level (Priority 1) that is higher than the first priority level (e.g., Priority 1>Priority 2). For example, the second querying device 605-a may transmit a CW portion 230 of a query to power-up the passive device, as shown in FIG. 2. As described previously herein, the priority level of the second operation may be explicitly or implicitly signaled via the query at 620, and/or determined based on the type of operation, a priority or identifier associated with the second querying device 605-b, based on a priority configuration, or any combination thereof.

At 625, the passive device may transmit a response message to the first querying device 605-b, where the response message indicates that the passive device has received a query for a higher-priority operation, and will therefore stop, cancel, or postpone the first operation initiated by the first querying device 605-a. In other words, the passive device may indicate, to the first querying device 605-b, that the passive device is prioritizing the second operation initiated by the second querying device 605-b over the first operation initiated by the first querying device 605-a.

At 630, 635, and 640, the passive device may cancel or otherwise refrain from performing the first operation initiated by the first querying device 605-a. The passive device may cancel or refrain from performing the first operation at 630 through 640 based on receiving the query for the higher-priority operation at 620, transmitting the response message to the first querying device 605-a at 625, or both.

At 645, 650, or both, the passive device may perform the second operation. For example, in the context of a write operation, the passive device may configure or modify one or more operational parameters of the passive device. Comparatively, in the context of a reading operation, the passive device may transmit signals to the second querying device 605-b (or a related reader device), where the signals indicate measurements performed by the passive device, a location of the passive device, and the like.

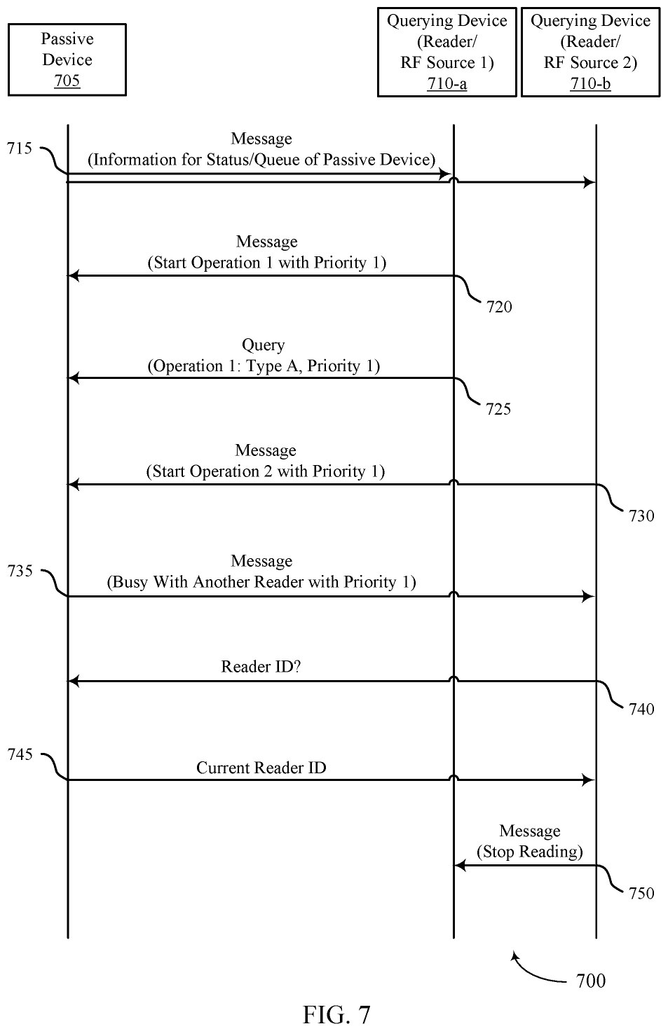

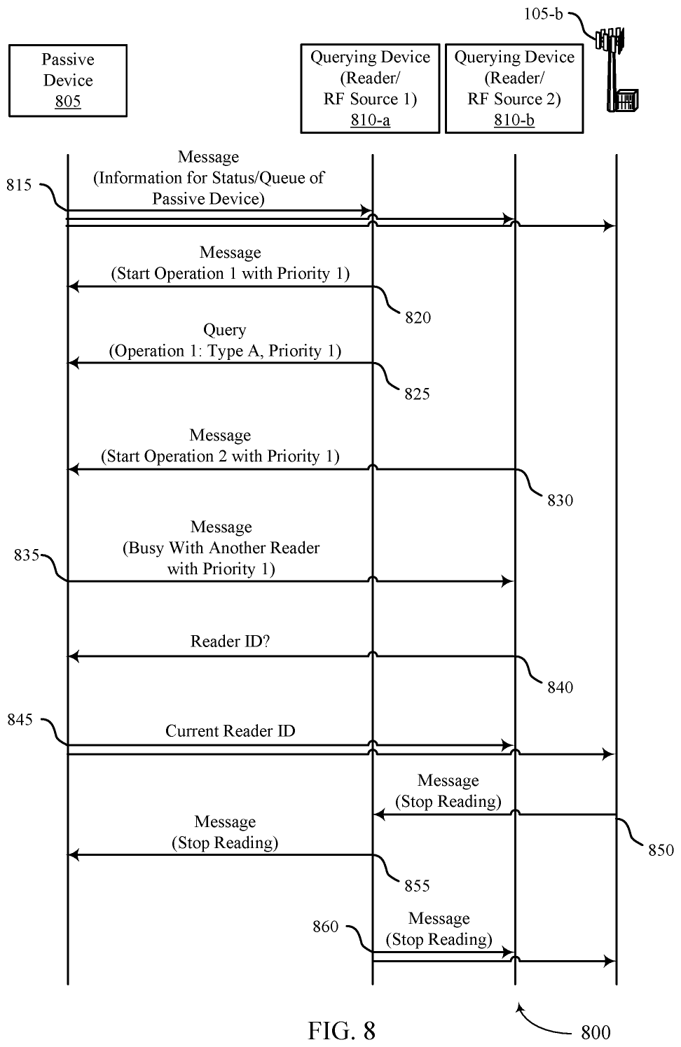

The signaling and operations shown and described in FIG. 6 may be further understood with reference to FIGS. 7 and 8.

FIG. 7 illustrates an example of a process flow 700 that supports techniques for prioritizing and handling conflicting read and write commands for passive devices in accordance with one or more aspects of the present disclosure. In some examples, aspects of the process flow 700 may implement, or be implemented by, aspects of the wireless communications system 100, the wireless communications system 200, the resource configuration 600, or any combination thereof. In particular, the process flow 700 illustrates signaling between querying devices and a passive device that enables a querying device to pre-empt a read/write operation that was previously initiated by another querying device with a higher-priority operation, as described with reference to FIGS. 1-6, among other aspects.

The process flow 700 may include a passive device 705, a first querying device 710-a, and a second querying device 710-b, which may be examples of passive devices, UEs 115, network entities 105, and other wireless devices described with reference to FIGS. 1-6. For example, the passive device 705 may include an example of an RFID tag or a passive component of a querying device, as shown and described in FIG. 2. Additionally, the first querying device 710-a may include an example of the first UE 115-a, the third UE 115-c, or both, as shown and described in FIG. 2. Similarly, the second querying device 710-b may include an example of the second UE 115-b, the fourth UE 115-d, or both, as shown and described in FIG. 2.

In some examples, the operations illustrated in process flow 700 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 715, the passive device 705 may transmit or broadcast, to the first querying device 710-a, the second querying device 710-b, or both, a message indicating information associated with a status or queue of operations to be performed at the passive device 705. In other words, the passive device 705 may transmit a message indicating whether the passive device 705 is available, or whether the passive device is booked/busy. In some cases, passive device 405 may transmit the message at 705 in accordance with some periodicity, where the periodicity may be pre-configured, signaled to the passive device 705 (e.g., via a write operation), or both. Moreover, in some cases, the passive device 705 may transmit the message at 715 based on receiving some RF signal (e.g., from the first querying device 710-a, second querying device 710-b, or other device, such as a network entity 105) that provides power for the passive device 705 to transmit the signal.

At 720, the first querying device 710-a may transmit, to the passive device 705, a signal or message to start a first operation (Operation 1) at the passive device 705. The first operation may include a read operation or a write operation that is to be performed by the passive device 705, where the first operation is associated with a first priority level (Priority 1). For example, the first querying device 710-a may transmit a CW portion 230 of a query to power-up the passive device, as shown in FIG. 2. As described previously herein, the priority level of the first operation may be explicitly or implicitly signaled via the message at 720, and/or determined based on the type of operation, a priority or identifier associated with the first querying device 710-a, based on a priority configuration, or any combination thereof. In some aspects, the first querying device 710-a may transmit the message at 720 based on receiving the message associated with the status/queue of the passive device 705 at 715.

At 725, the first querying device 710-a may transmit a query or command for the first operation. For example, the first querying device 710-a may transmit a command 235-a for the first operation, as shown in FIG. 2. As such, the first querying device 710-a may transmit the query at 720 based on transmitting the message to initiate the first operation at 720, and/or receiving the message associated with the status/queue of the passive device 705 at 715. In some aspects, the query at 725 may indicate an operation type associated with the first operation (e.g., Type A), the priority level associated with the first operation, or both.

At 730, the second querying device 710-b may transmit a message (e.g., query, command) for the passive device 705 to perform a second operation (Operation 2) with a same or higher priority (e.g., Priority 1) as compared to the first operation. In other words, the second querying device 710-b may attempt to pre-empt the first operation at the passive device 705 by transmitting the query for the second operation. In some aspects, the second querying device 710-b may transmit the message at 730 based on receiving the message associated with the status/queue of the passive device 705 at 715.

At 735, the passive device 705 may transmit a response message to the second querying device 710-b, where the response message indicates that the passive device 705 is busy communicating with another reader/querying device for an operation/session with the same or higher priority. In other words, the passive device 705 may indicate, to the second querying device 710-b, that the passive device 705 is prioritizing Operation 1 initiated by the first querying device 710-a over Operation 2 initiated by the second querying device 710-b. In some implementations, the passive device 705 may transmit the response message to both the first and second querying devise 710 so that the querying devices 710 can predict or expect the behavior of the passive device 705.

At 740, the second querying device 710-b may transmit a request for an identity or identifier associated with the previously-initiated operation that is being prioritized at the passive device 705. In other words, the second querying device 710-b may request a reader ID associated with the querying device 710 (e.g., first querying device 710-a) that initiated Operation 1 that is being prioritized over Operation 2. The second querying device 710-b may transmit the request at 740 based on transmitting the query/message at 730, receiving the response message at 735, or both.

At 745, the passive device 705 may transmit, to the second querying device 710-b, a message indicating an identifier associated with the first querying device 710-a. In other words, the passive device 705 may transmit a message indicating a reader ID of the first querying device 710-a. The passive device 705 may transmit the message indicating the current reader ID at 745 based on (e.g., in response to) receiving the request at 740.

At 750, the second querying device 710-b may transmit a message to the first querying device 710-a, where the message indicates that the second querying device 710-b has an operation to be performed with the passive device 705 with the same or higher priority as the operation that was previously initiated by the first querying device 710-a. In this regard, in some cases, the message at 750 may include a request or instruction for the first querying device 710-a to stop, cancel, or postpone the first operation so that the passive device 705 can perform or prioritize the second operation initiated by the second querying device 710-b. In some cases, the message at 750 may indicate information associated with the second operation, such as the priority level, the operation type, an identifier associated with the second querying device 710-b, or any combination thereof. Moreover, the second querying device 710-b may transmit the message at 750 based on receiving the identifier (e.g., reader ID) associated with the first querying device 710-a at 745.

Upon receiving the message at 750, the first querying device 710-a and the second querying device 710-b may coordinate or negotiate which operation will be performed/prioritized at the passive device 705. In some implementations, the first querying device 710-a may stop, cancel, or postpone the first operation in response to the message at 750. In such cases, the first querying device 710-a may transmit a message to the passive device 705 to stop, cancel or postpone the first operation. Additionally, in some cases, the first querying device 710-a and/or the passive device 705 may transmit a message to the second querying device 710-b indicating that the first operation has been postponed. In this regard, the second querying device 710-b may transmit a query to the passive device 705 to re-initiate the second operation (Operation 2).

Techniques described herein may enable the passive device 705 and the querying devices 710 to exchange information with one another (e.g., identifiers of querying devices 710, or reader IDs) to enable the querying devices 710 to coordinate or negotiate which operations will be performed and/or prioritized at the passive device 705.

FIG. 8 illustrates an example of a process flow 800 that supports techniques for prioritizing and handling conflicting read and write commands for passive devices in accordance with one or more aspects of the present disclosure. In some examples, aspects of the process flow 700 may implement, or be implemented by, aspects of the wireless communications system 100, the wireless communications system 200, the resource configuration 600, the process flow 700, or any combination thereof. In particular, the process flow 800 illustrates signaling between querying devices and a passive device that enables a querying device to pre-empt a read/write operation that was previously initiated by another querying device with a higher-priority operation, as described with reference to FIGS. 1-7, among other aspects.

The process flow 800 may include a passive device 805, a first querying device 810-a, a second querying device 810-b, and a network entity 105-b, which may be examples of passive devices, UEs 115, network entities 105, and other wireless devices described with reference to FIGS. 1-7. For example, the passive device 805 may include an example of an RFID tag or a passive component of a querying device, as shown and described in FIG. 2. Additionally, the first querying device 810-a may include an example of the first UE 115-a, the third UE 115-c, or both, as shown and described in FIG. 2. Similarly, the second querying device 810-b may include an example of the second UE 115-b, the fourth UE 115-d, or both, as shown and described in FIG. 2. Moreover, the network entity 105-b illustrated in FIG. 8 may include an example of the network entity 105-a shown and described in FIG. 2.

In some examples, the operations illustrated in process flow 800 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 815, the passive device 805 may transmit or broadcast, to the first querying device 810-a, the second querying device 810-b, or both, a message indicating information associated with a status or queue of operations to be performed at the passive device 805. In other words, the passive device 805 may transmit a message indicating whether the passive device 805 is available, or whether the passive device is booked/busy. In some cases, passive device 405 may transmit the message at 805 in accordance with some periodicity, where the periodicity may be pre-configured, signaled to the passive device 805 (e.g., via a write operation), or both. Moreover, in some cases, the passive device 805 may transmit the message at 815 based on receiving some RF signal (e.g., from the first querying device 810-a, the second querying device 810-b, the network entity 105-b, etc.) that provides power for the passive device 805 to transmit the signal.

At 820, the first querying device 810-a may transmit, to the passive device 805, a signal or message to start a first operation (Operation 1) at the passive device 805. The first operation may include a read operation or a write operation that is to be performed by the passive device 805, where the first operation is associated with a first priority level (Priority 1). For example, the first querying device 810-a may transmit a CW portion 230 of a query to power-up the passive device, as shown in FIG. 2. As described previously herein, the priority level of the first operation may be explicitly or implicitly signaled via the message at 820, and/or determined based on the type of operation, a priority or identifier associated with the first querying device 810-a, based on a priority configuration, or any combination thereof. In some aspects, the first querying device 810-a may transmit the message at 820 based on receiving the message associated with the status/queue of the passive device 805 at 815.

At 825, the first querying device 810-a may transmit a query or command for the first operation. For example, the first querying device 810-a may transmit a command 235-a for the first operation, as shown in FIG. 2. As such, the first querying device 810-a may transmit the query at 820 based on transmitting the message to initiate the first operation at 820, and/or receiving the message associated with the status/queue of the passive device 805 at 815. In some aspects, the query at 825 may indicate an operation type associated with the first operation (e.g., Type A), the priority level associated with the first operation, or both.

At 830, the second querying device 810-b may transmit a message (e.g., query, command) for the passive device 805 to perform a second operation (Operation 2) with a same or higher priority (e.g., Priority 1) as compared to the first operation. In other words, the second querying device 810-b may attempt to pre-empt the first operation at the passive device 805 by transmitting the query for the second operation. In some aspects, the second querying device 810-b may transmit the message at 830 based on receiving the message associated with the status/queue of the passive device 805 at 815.

At 835, the passive device 805 may transmit a response message to the second querying device 810-b, where the response message indicates that the passive device 805 is busy communicating with another reader/querying device for an operation/session with the same or higher priority. In other words, the passive device 805 may indicate, to the second querying device 810-b, that the passive device 805 is prioritizing Operation 1 initiated by the first querying device 810-a over Operation 2 initiated by the second querying device 810-b. In some implementations, the passive device 805 may transmit the response message to both the first and second querying devise 810 so that the querying devices 810 can predict or expect the behavior of the passive device 805.

At 840, the second querying device 810-b may transmit a request for an identity or identifier associated with the previously-initiated operation that is being prioritized at the passive device 805. In other words, the second querying device 810-b may request a reader ID associated with the querying device 810 (e.g., first querying device 810-a) that initiated Operation 1 that is being prioritized over Operation 2. The second querying device 810-b may transmit the request at 840 based on transmitting the query/message at 830, receiving the response message at 835, or both.

At 845, the passive device 805 may transmit, to the second querying device 810-b, the network entity 105-b, or both, a message indicating an identifier associated with the first querying device 810-a. In other words, the passive device 805 may transmit a message indicating a reader ID of the first querying device 810-a. The passive device 805 may transmit the message indicating the current reader ID at 845 based on (e.g., in response to) receiving the request at 840.

At 850, the network entity 105-b may transmit a message to the first querying device 810-a, where the message indicates that the second querying device 810-b has an operation to be performed with the passive device 805 with the same or higher priority as the operation that was previously initiated by the first querying device 810-a. In this regard, in some cases, the message at 850 may include a request or instruction for the first querying device 810-a to stop, cancel, or postpone the first operation so that the passive device 805 can perform or prioritize the second operation initiated by the second querying device 810-b. In some cases, the message at 850 may indicate information associated with the second operation, such as the priority level, the operation type, an identifier associated with the second querying device 810-b, or any combination thereof. Moreover, the network entity 105-b may transmit the message at 850 based on receiving the identifier (e.g., reader ID) associated with the first querying device 810-a at 845.

At 855, the first querying device 810-a may transmit a message to the passive device 805 to stop, cancel or postpone the first operation. The first querying device 810-a may transmit the message at 855 based on receiving the message at 850.

At 860, the first querying device 810-a may transmit a message to the second querying device 810-b, the network entity 105-b, or both, where the message indicates that the first querying device 810-a has canceled or postponed the first operation. In this regard, the first querying device 810-a may transmit the message at 860 based on receiving the message at 850, transmitting the message at 855, or both.

In some aspects, the second querying device 810-b may transmit a query to the passive device 805 to re-initiate the second operation (Operation 2) after receiving the message at 860 indicating that the first querying device 810-a canceled or postponed the first operation.

Techniques described herein may enable the passive device 805 and the querying devices 810 to exchange information with one another (e.g., identifiers of querying devices 810, or reader IDs) to enable the querying devices 810 to coordinate or negotiate which operations will be performed and/or prioritized at the passive device 805.

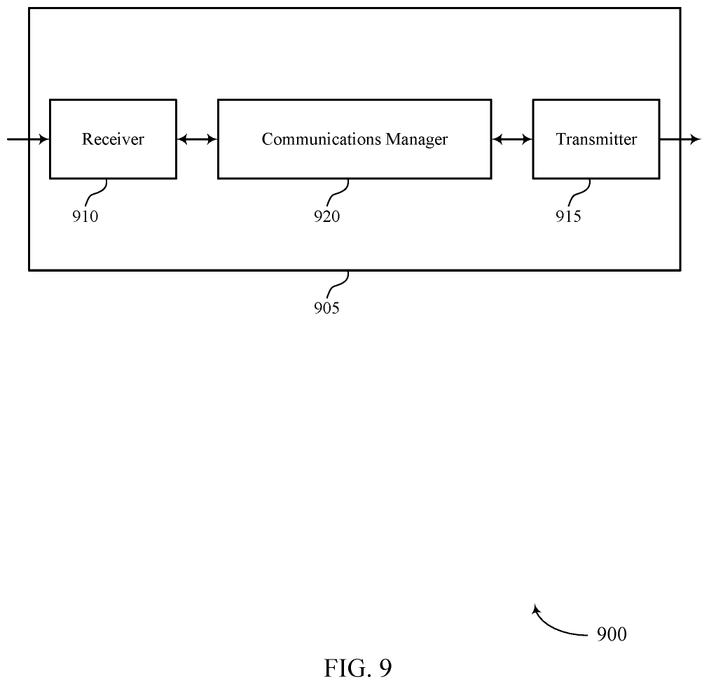

FIG. 9 shows a block diagram 900 of a device 905 that supports techniques for prioritizing and handling conflicting read and write commands for passive devices in accordance with one or more aspects of the present disclosure. The device 905 may be an example of aspects of a passive device (e.g., RFID tag, passive IoT device, hybrid devices including passive and active components, passive components of a UE 115) as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for prioritizing and handling conflicting read and write commands for passive devices). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for prioritizing and handling conflicting read and write commands for passive devices). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for prioritizing and handling conflicting read and write commands for passive devices as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a passive device in accordance with examples as disclosed herein. For example, the communications manager 920 may be configured as or otherwise support a means for receiving, from a first querying device, a first query associated with a first operation to be performed at the passive device, where the first operation is associated with a first priority level and includes a first write operation, a first read operation, or both. The communications manager 920 may be configured as or otherwise support a means for receiving, from the first querying device or a second querying device, a second query associated with a second operation to be performed at the passive device, where the second operation is associated with a second priority level and includes a second write operation, a second read operation, or both. The communications manager 920 may be configured as or otherwise support a means for transmitting, to the first querying device, the second querying device, or both, a message indicating a status of the first operation, the second operation, or both. The communications manager 920 may be configured as or otherwise support a means for performing one of the first operation or the second operation in accordance with the first priority level and the second priority level and based on transmitting the message.

By including or configuring the communications manager 920 in accordance with examples as described herein, the device 905 (e.g., a processor controlling or otherwise coupled with the receiver 910, the transmitter 915, the communications manager 920, or a combination thereof) may support techniques that enable passive devices, such as RFID tags, to determine relative priorities of read and write operations that are to be performed at the passive devices, thereby improving the speed and efficiency with which passive devices are able to perform reading and writing operations. As such, techniques described herein may improve the efficiency and latency of services and applications associated with passive devices within a wireless communications system, such as location tracking services. Moreover, techniques described herein may enable querying devices to quickly and efficiently determine a status of respective passive devices (e.g., whether each passive device is available or busy), thereby facilitating the ability of querying devices to identify passive devices that may be used for wireless communications.

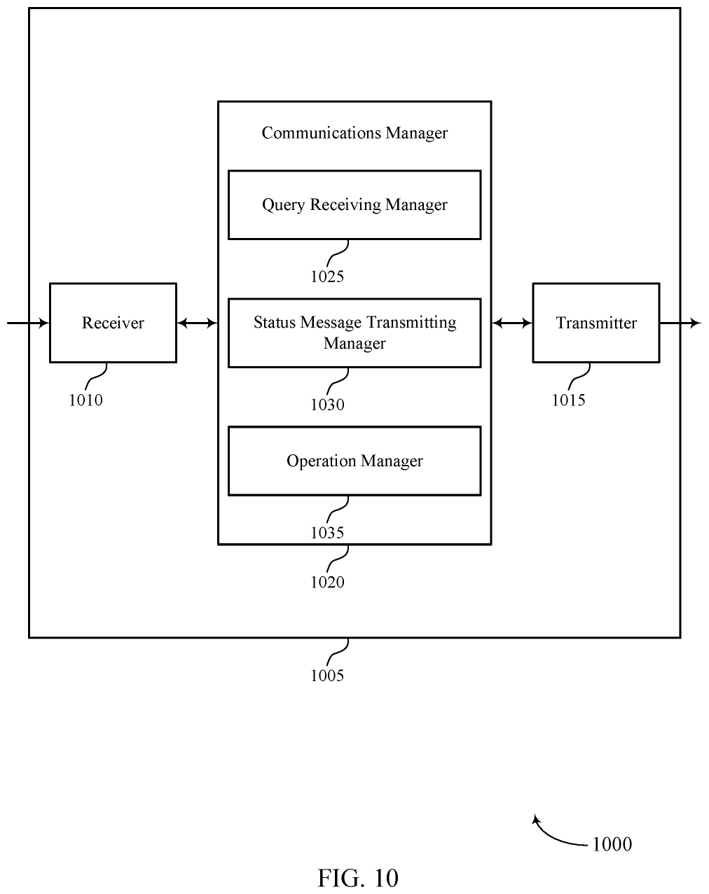

FIG. 10 shows a block diagram 1000 of a device 1005 that supports techniques for prioritizing and handling conflicting read and write commands for passive devices in accordance with one or more aspects of the present disclosure. The device 1005 may be an example of aspects of a device 905 or a passive device as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for prioritizing and handling conflicting read and write commands for passive devices). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for prioritizing and handling conflicting read and write commands for passive devices). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for prioritizing and handling conflicting read and write commands for passive devices as described herein. For example, the communications manager 1020 may include a query receiving manager 1025, a status message transmitting manager 1030, an operation manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a passive device in accordance with examples as disclosed herein. The query receiving manager 1025 may be configured as or otherwise support a means for receiving, from a first querying device, a first query associated with a first operation to be performed at the passive device, where the first operation is associated with a first priority level and includes a first write operation, a first read operation, or both. The query receiving manager 1025 may be configured as or otherwise support a means for receiving, from the first querying device or a second querying device, a second query associated with a second operation to be performed at the passive device, where the second operation is associated with a second priority level and includes a second write operation, a second read operation, or both. The status message transmitting manager 1030 may be configured as or otherwise support a means for transmitting, to the first querying device, the second querying device, or both, a message indicating a status of the first operation, the second operation, or both. The operation manager 1035 may be configured as or otherwise support a means for performing one of the first operation or the second operation in accordance with the first priority level and the second priority level and based on transmitting the message.

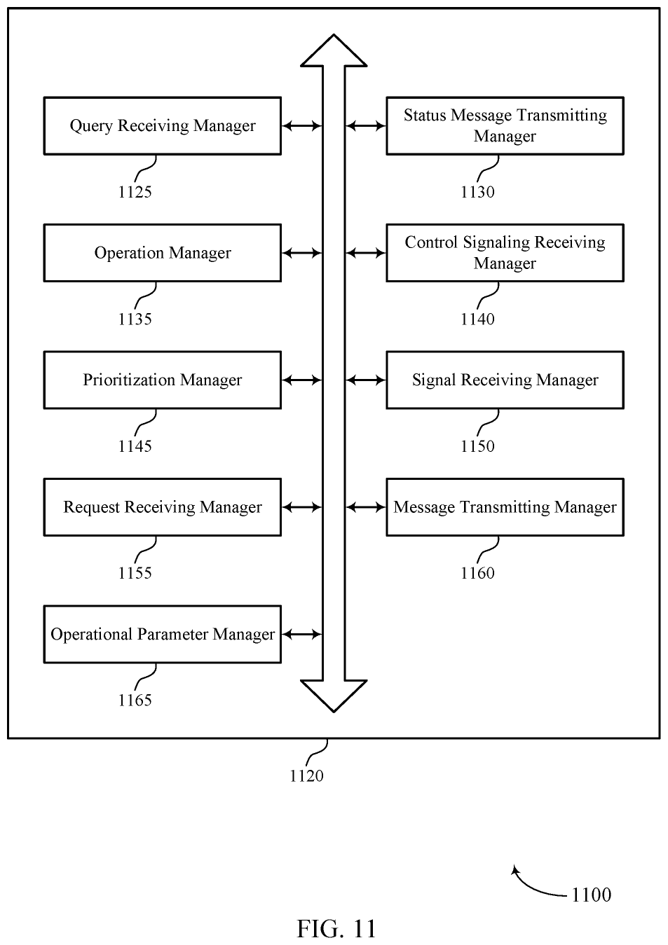

FIG. 11 shows a block diagram 1100 of a communications manager 1120 that supports techniques for prioritizing and handling conflicting read and write commands for passive devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for prioritizing and handling conflicting read and write commands for passive devices as described herein. For example, the communications manager 1120 may include a query receiving manager 1125, a status message transmitting manager 1130, an operation manager 1135, a control signaling receiving manager 1140, a prioritization manager 1145, a signal receiving manager 1150, a request receiving manager 1155, a message transmitting manager 1160, an operational parameter manager 1165, or any combination thereof. Each of these components may communicate, directly or indirectly, with one another (e.g., via one or more buses).

The communications manager 1120 may support wireless communication at a passive device in accordance with examples as disclosed herein. The query receiving manager 1125 may be configured as or otherwise support a means for receiving, from a first querying device, a first query associated with a first operation to be performed at the passive device, where the first operation is associated with a first priority level and includes a first write operation, a first read operation, or both. In some examples, the query receiving manager 1125 may be configured as or otherwise support a means for receiving, from the first querying device or a second querying device, a second query associated with a second operation to be performed at the passive device, where the second operation is associated with a second priority level and includes a second write operation, a second read operation, or both. The status message transmitting manager 1130 may be configured as or otherwise support a means for transmitting, to the first querying device, the second querying device, or both, a message indicating a status of the first operation, the second operation, or both. The operation manager 1135 may be configured as or otherwise support a means for performing one of the first operation or the second operation in accordance with the first priority level and the second priority level and based on transmitting the message.

In some examples, the query receiving manager 1125 may be configured as or otherwise support a means for receiving the first priority level via the first query. In some examples, the query receiving manager 1125 may be configured as or otherwise support a means for receiving the second priority level via the second query, where transmitting the message is based on the first priority level, the second priority level, or both. In some examples, the first priority level is based on the first operation including the first write operation. In some examples, the second priority level is based on the second operation including the second read operation.

In some examples, the prioritization manager 1145 may be configured as or otherwise support a means for prioritizing the first operation over the second read operation based on the first priority level being greater than the second priority level, where transmitting the message is based on the prioritizing, and where performing one of the first operation or the second operation includes performing the first operation based on the prioritizing.

In some examples, the control signaling receiving manager 1140 may be configured as or otherwise support a means for receiving, from the first querying device, the second querying device, or an additional wireless device, control signaling indicating a priority configuration usable for determining priority levels associated with operations to be performed at the passive device. In some examples, the prioritization manager 1145 may be configured as or otherwise support a means for determining the first priority level, the second priority level, or both, in accordance with the priority configuration, where transmitting the message, performing one of the first operation or the second operation, or both, is based on determining the first priority level, the second priority level, or both.

In some examples, the priority configuration includes one or more rules, one or more conditions, or both, for determining priority levels associated with operations to be performed at the passive device. In some examples, determining the first priority level, the second priority level, or both, is based on the one or more rules, the one or more conditions, or both.

In some examples, the first priority level is based on a first operation type associated with the first operation. In some examples, the second priority level is based on a second operation type associated with the second operation. In some examples, the second query is received from the second querying device. In some examples, the first priority level is based on a first identifier associated with the first querying device. In some examples, the second priority level is based on a second identifier associated with the second querying device.

In some examples, the status message transmitting manager 1130 may be configured as or otherwise support a means for transmitting the message to at least the second querying device based on the first priority level being greater than the second priority level, where the message includes an indication that the passive device is busy performing the first operation. In some examples, the status message transmitting manager 1130 may be configured as or otherwise support a means for transmitting the message to at least the first querying device based on the first priority level being less than the second priority level, where the message includes an indication that the passive device has received the second query for the second operation having a higher priority than the first operation.

In some examples, the status message transmitting manager 1130 may be configured as or otherwise support a means for transmitting, via the message, an indication of the first priority level, the second priority level, a first operation type associated with the first operation, a second operation type associated with the second operation, a first identifier associated with the first querying device, a second identifier associated with the second querying device, or any combination thereof.

In some examples, the second query is received from the first querying device, and the signal receiving manager 1150 may be configured as or otherwise support a means for receiving, via the second query, an instruction to stop the first operation and to perform the second operation, where the passive device performs the second operation based on the instruction.

In some examples, the status message transmitting manager 1130 may be configured as or otherwise support a means for transmitting a set of multiple messages in accordance with a periodicity, the set of multiple messages associated with a queue of operations to be performed by the passive device, the set of multiple messages including the message indicating the status of the first operation, the second operation, or both.

In some examples, the signal receiving manager 1150 may be configured as or otherwise support a means for receiving a set of multiple signals in accordance with the periodicity, where transmitting the set of multiple messages is based on receiving the set of multiple signals.

In some examples, the message includes an indication that the passive device is busy performing the first operation, and the request receiving manager 1155 may be configured as or otherwise support a means for receiving, from the second querying device and in response to the message, a request for an identifier associated with the first querying device. In some examples, the message includes an indication that the passive device is busy performing the first operation, and the message transmitting manager 1160 may be configured as or otherwise support a means for transmitting a second message to the second querying device based on receiving the request, the second message indicating the identifier associated with the first querying device.

In some examples, the first operation may be performed at a first time, and the operation manager 1135 may be configured as or otherwise support a means for performing the second operation at a second time subsequent to the first time based on the second priority level being less than the first priority level.

In some examples, to support performing one of the first write operation or the second write operation, the operational parameter manager 1165 may be configured as or otherwise support a means for adjusting one or more operational parameters at the passive device.

In some examples, to support performing one of the first read operation or the second read operation, the message transmitting manager 1160 may be configured as or otherwise support a means for transmitting a data message to the first querying device, the second querying device, or both.

In some examples, the passive device includes an RFID tag, a passive component of a wireless device, or both. In some examples, the first querying device, the second querying device, or both, include a UE, a network entity, or both.

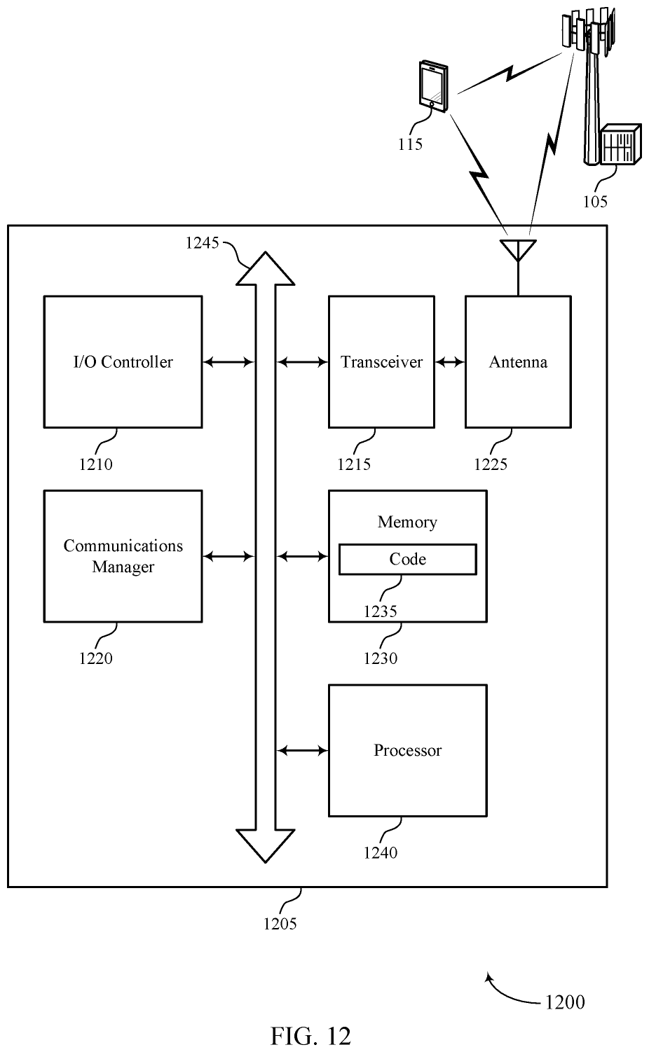

FIG. 12 shows a diagram of a system 1200 including a device 1205 that supports techniques for prioritizing and handling conflicting read and write commands for passive devices in accordance with one or more aspects of the present disclosure. The device 1205 may be an example of or include the components of a device 905, a device 1005, or a passive device as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for prioritizing and handling conflicting read and write commands for passive devices). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a passive device in accordance with examples as disclosed herein. For example, the communications manager 1220 may be configured as or otherwise support a means for receiving, from a first querying device, a first query associated with a first operation to be performed at the passive device, where the first operation is associated with a first priority level and includes a first write operation, a first read operation, or both. The communications manager 1220 may be configured as or otherwise support a means for receiving, from the first querying device or a second querying device, a second query associated with a second operation to be performed at the passive device, where the second operation is associated with a second priority level and includes a second write operation, a second read operation, or both. The communications manager 1220 may be configured as or otherwise support a means for transmitting, to the first querying device, the second querying device, or both, a message indicating a status of the first operation, the second operation, or both. The communications manager 1220 may be configured as or otherwise support a means for performing one of the first operation or the second operation in accordance with the first priority level and the second priority level and based on transmitting the message.

By including or configuring the communications manager 1220 in accordance with examples as described herein, the device 1205 may support techniques that enable passive devices, such as RFID tags, to determine relative priorities of read and write operations that are to be performed at the passive devices, thereby improving the speed and efficiency with which passive devices are able to perform reading and writing operations. As such, techniques described herein may improve the efficiency and latency of services and applications associated with passive devices within a wireless communications system, such as location tracking services. Moreover, techniques described herein may enable querying devices to quickly and efficiently determine a status of respective passive devices (e.g., whether each passive device is available or busy), thereby facilitating the ability of querying devices to identify passive devices that may be used for wireless communications.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for prioritizing and handling conflicting read and write commands for passive devices as described herein, or the processor 1240 and the memory 1230 may be otherwise configured to perform or support such operations.

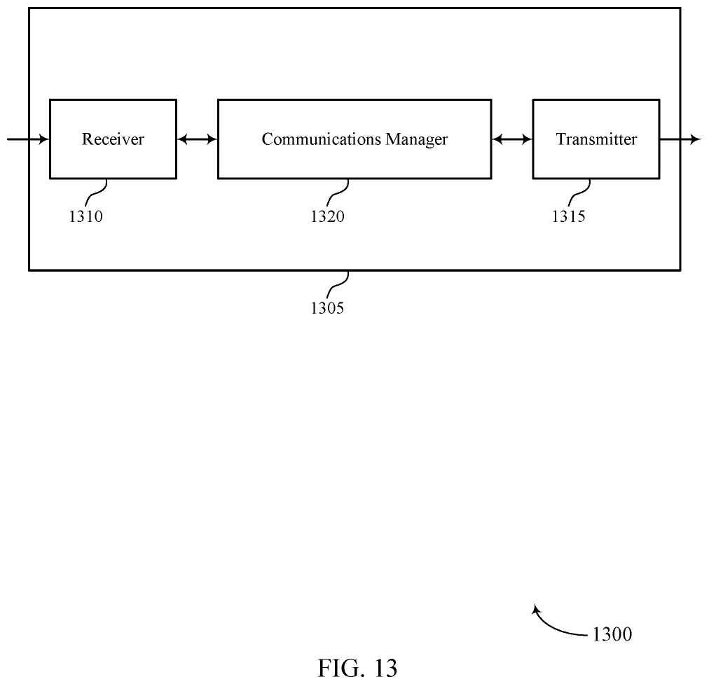

FIG. 13 shows a block diagram 1300 of a device 1305 that supports techniques for prioritizing and handling conflicting read and write commands for passive devices in accordance with one or more aspects of the present disclosure. The device 1305 may be an example of aspects of a querying device (e.g., UE 115, network entity 105) as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of techniques for prioritizing and handling conflicting read and write commands for passive devices as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a querying device in accordance with examples as disclosed herein. For example, the communications manager 1320 may be configured as or otherwise support a means for transmitting, to a passive device, a first query associated with a first operation to be performed at the passive device, where the first operation is associated with a first priority level and includes a first write operation, a first read operation, or both. The communications manager 1320 may be configured as or otherwise support a means for receiving, from the passive device based on the first query, a message indicating a status of the first operation, a second operation associated with a second priority level, or both, where the status is based on the first priority level, the second priority level or both, and where the second operation includes a second write operation, a second read operation, or both.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques that enable passive devices, such as RFID tags, to determine relative priorities of read and write operations that are to be performed at the passive devices, thereby improving the speed and efficiency with which passive devices are able to perform reading and writing operations. As such, techniques described herein may improve the efficiency and latency of services and applications associated with passive devices within a wireless communications system, such as location tracking services. Moreover, techniques described herein may enable querying devices to quickly and efficiently determine a status of respective passive devices (e.g., whether each passive device is available or busy), thereby facilitating the ability of querying devices to identify passive devices that may be used for wireless communications.

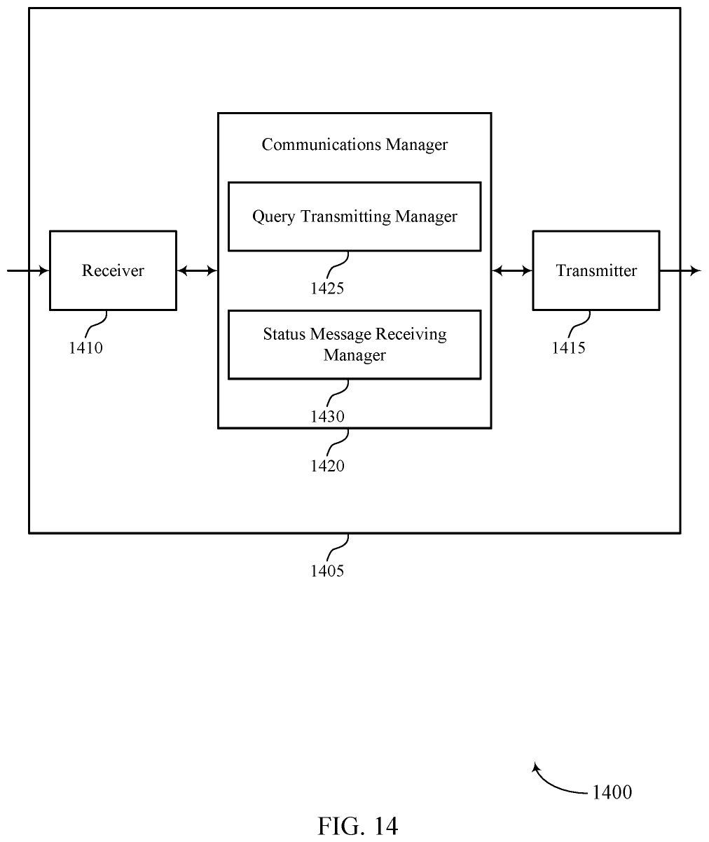

FIG. 14 shows a block diagram 1400 of a device 1405 that supports techniques for prioritizing and handling conflicting read and write commands for passive devices in accordance with one or more aspects of the present disclosure. The device 1405 may be an example of aspects of a device 1305 or a querying device (e.g., UE 115, network entity 105) as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of techniques for prioritizing and handling conflicting read and write commands for passive devices as described herein. For example, the communications manager 1420 may include a query transmitting manager 1425 a status message receiving manager 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a querying device in accordance with examples as disclosed herein. The query transmitting manager 1425 may be configured as or otherwise support a means for transmitting, to a passive device, a first query associated with a first operation to be performed at the passive device, where the first operation is associated with a first priority level and includes a first write operation, a first read operation, or both. The status message receiving manager 1430 may be configured as or otherwise support a means for receiving, from the passive device based on the first query, a message indicating a status of the first operation, a second operation associated with a second priority level, or both, where the status is based on the first priority level, the second priority level or both, and where the second operation includes a second write operation, a second read operation, or both.

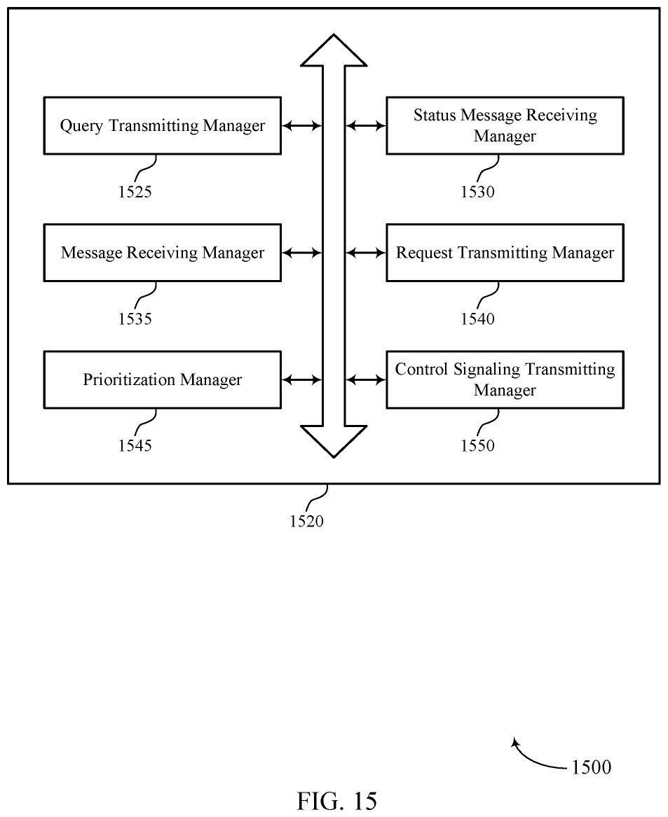

FIG. 15 shows a block diagram 1500 of a communications manager 1520 that supports techniques for prioritizing and handling conflicting read and write commands for passive devices in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of techniques for prioritizing and handling conflicting read and write commands for passive devices as described herein. For example, the communications manager 1520 may include a query transmitting manager 1525, a status message receiving manager 1530, a message receiving manager 1535, a request transmitting manager 1540, a prioritization manager 1545, a control signaling transmitting manager 1550, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a querying device in accordance with examples as disclosed herein. The query transmitting manager 1525 may be configured as or otherwise support a means for transmitting, to a passive device, a first query associated with a first operation to be performed at the passive device, where the first operation is associated with a first priority level and includes a first write operation, a first read operation, or both. The status message receiving manager 1530 may be configured as or otherwise support a means for receiving, from the passive device based on the first query, a message indicating a status of the first operation, a second operation associated with a second priority level, or both, where the status is based on the first priority level, the second priority level or both, and where the second operation includes a second write operation, a second read operation, or both.

In some examples, the message receiving manager 1535 may be configured as or otherwise support a means for receiving, from the passive device, a second message including an indicator associated with a second querying device and a request to stop an operation to be performed at the passive device that was initiated by the second querying device. In some examples, the request transmitting manager 1540 may be configured as or otherwise support a means for transmitting, to the second querying device based on the second message, a third message indicating the request for the second querying device to stop the operation initiated by the second querying device.

In some examples, the query transmitting manager 1525 may be configured as or otherwise support a means for transmitting the first priority level via the first query, where receiving the message is based on the first priority level.

In some examples, where the first priority level is based on the first operation including the first write operation or the first read operation, and where the second priority level is based on the second operation including the second write operation or the second read operation. In some examples, where the first priority level is based on a first operation type associated with the first operation, and where the second priority level is based on a second operation type associated with the second operation.

In some examples, the control signaling transmitting manager 1550 may be configured as or otherwise support a means for transmitting, to the passive device, control signaling indicating a priority configuration usable for determining priority levels associated with operations to be performed at the passive device, where receiving the message is based on the priority configuration.

In some examples, the status message receiving manager 1530 may be configured as or otherwise support a means for receiving the message from the passive device based on the first priority level being less than the second priority level, where the message includes an indication that the second operation has a higher priority than the first operation. In some examples, the status message receiving manager 1530 may be configured as or otherwise support a means for receiving the message from the passive device based on the first priority level being less than the second priority level, where the message includes an indication that the second operation has a higher priority than the first operation, where the second operation is associated with a second querying device.

In some examples, the request transmitting manager 1540 may be configured as or otherwise support a means for transmitting, to the passive device and in response to the message, a request for an identifier associated with the second querying device. In some examples, the message receiving manager 1535 may be configured as or otherwise support a means for receiving a second message from the passive device based on transmitting the request, the second message indicating the identifier associated with the second querying device. In some examples, the request transmitting manager 1540 may be configured as or otherwise support a means for transmitting a third message to the second querying device based on receiving the second message, the third message including a second request for the second querying device to stop the second operation.

In some examples, the query transmitting manager 1525 may be configured as or otherwise support a means for transmitting, to the passive device, a second query associated with the second operation, where the second query includes an instruction for the passive device to stop the first operation and to perform the second operation.

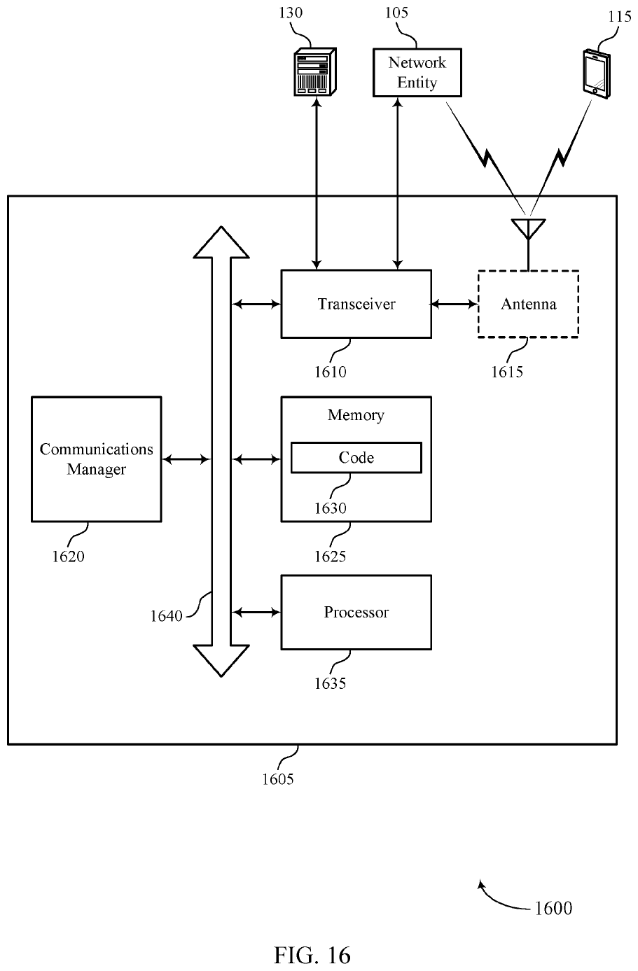

FIG. 16 shows a diagram of a system 1600 including a device 1605 that supports techniques for prioritizing and handling conflicting read and write commands for passive devices in accordance with one or more aspects of the present disclosure. The device 1605 may be an example of or include the components of a device 1305, a device 1405, or a querying device (e.g., UE 115, network entity 105) as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. The transceiver 1610, or the transceiver 1610 and one or more antennas 1615 or wired interfaces, where applicable, may be an example of a transmitter 1315, a transmitter 1415, a receiver 1310, a receiver 1410, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting techniques for prioritizing and handling conflicting read and write commands for passive devices). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a querying device in accordance with examples as disclosed herein. For example, the communications manager 1620 may be configured as or otherwise support a means for transmitting, to a passive device, a first query associated with a first operation to be performed at the passive device, where the first operation is associated with a first priority level and includes a first write operation, a first read operation, or both. The communications manager 1620 may be configured as or otherwise support a means for receiving, from the passive device based on the first query, a message indicating a status of the first operation, a second operation associated with a second priority level, or both, where the status is based on the first priority level, the second priority level or both, and where the second operation includes a second write operation, a second read operation, or both.

By including or configuring the communications manager 1620 in accordance with examples as described herein, the device 1605 may support techniques that enable passive devices, such as RFID tags, to determine relative priorities of read and write operations that are to be performed at the passive devices, thereby improving the speed and efficiency with which passive devices are able to perform reading and writing operations. As such, techniques described herein may improve the efficiency and latency of services and applications associated with passive devices within a wireless communications system, such as location tracking services. Moreover, techniques described herein may enable querying devices to quickly and efficiently determine a status of respective passive devices (e.g., whether each passive device is available or busy), thereby facilitating the ability of querying devices to identify passive devices that may be used for wireless communications.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the processor 1635, the memory 1625, the code 1630, the transceiver 1610, or any combination thereof. For example, the code 1630 may include instructions executable by the processor 1635 to cause the device 1605 to perform various aspects of techniques for prioritizing and handling conflicting read and write commands for passive devices as described herein, or the processor 1635 and the memory 1625 may be otherwise configured to perform or support such operations.

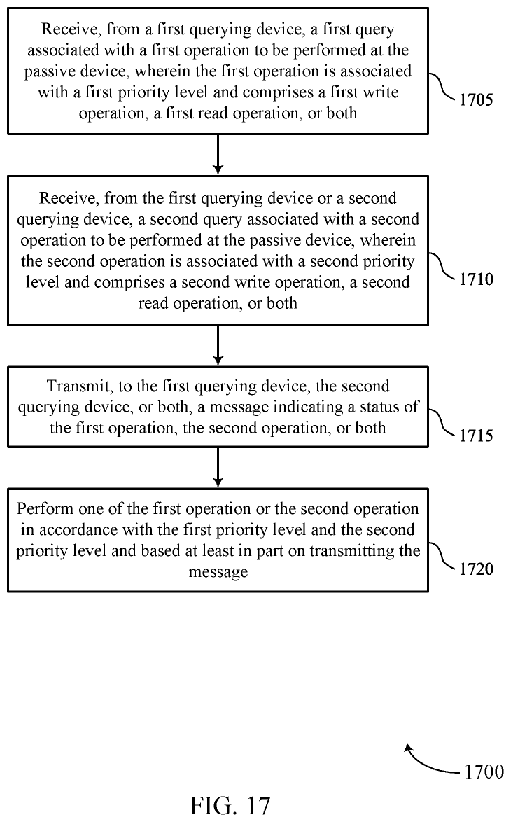

FIG. 17 shows a flowchart illustrating a method 1700 that supports techniques for prioritizing and handling conflicting read and write commands for passive devices in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving, from a first querying device, a first query associated with a first operation to be performed at the passive device, where the first operation is associated with a first priority level and includes a first write operation, a first read operation, or both. The operations of 1705 may be performed in accordance with examples as disclosed herein. In some examples, aspects of the operations of 1705 may be performed by a query receiving manager 1125 as described with reference to FIG. 11.

At 1710, the method may include receiving, from the first querying device or a second querying device, a second query associated with a second operation to be performed at the passive device, where the second operation is associated with a second priority level and includes a second write operation, a second read operation, or both. The operations of 1710 may be performed in accordance with examples as disclosed herein. In some examples, aspects of the operations of 1710 may be performed by a query receiving manager 1125 as described with reference to FIG. 11.

At 1715, the method may include transmitting, to the first querying device, the second querying device, or both, a message indicating a status of the first operation, the second operation, or both. The operations of 1715 may be performed in accordance with examples as disclosed herein. In some examples, aspects of the operations of 1715 may be performed by a status message transmitting manager 1130 as described with reference to FIG. 11.

At 1720, the method may include performing one of the first operation or the second operation in accordance with the first priority level and the second priority level and based on transmitting the message. The operations of 1720 may be performed in accordance with examples as disclosed herein. In some examples, aspects of the operations of 1720 may be performed by an operation manager 1135 as described with reference to FIG. 11.

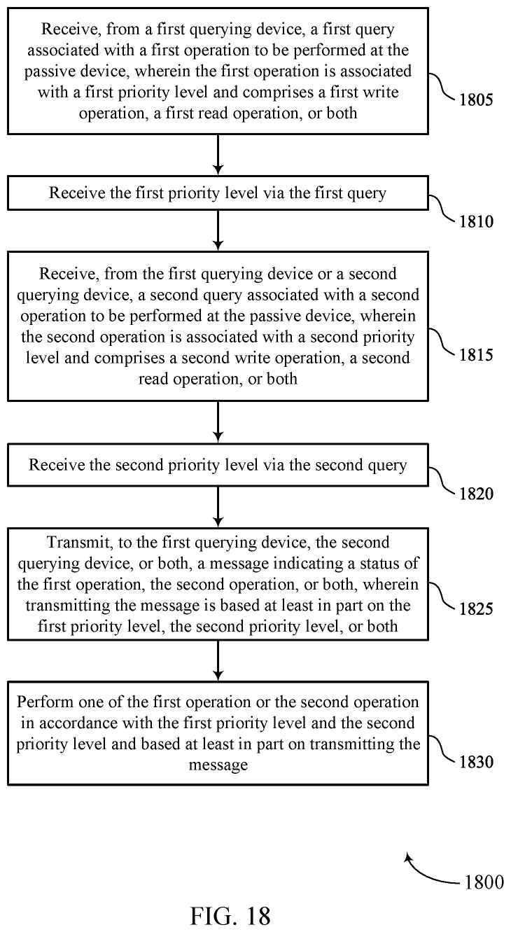

FIG. 18 shows a flowchart illustrating a method 1800 that supports techniques for prioritizing and handling conflicting read and write commands for passive devices in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving, from a first querying device, a first query associated with a first operation to be performed at the passive device, where the first operation is associated with a first priority level and includes a first write operation, a first read operation, or both. The operations of 1805 may be performed in accordance with examples as disclosed herein. In some examples, aspects of the operations of 1805 may be performed by a query receiving manager 1125 as described with reference to FIG. 11.

At 1810, the method may include receiving the first priority level via the first query. The operations of 1810 may be performed in accordance with examples as disclosed herein. In some examples, aspects of the operations of 1810 may be performed by a query receiving manager 1125 as described with reference to FIG. 11.

At 1815, the method may include receiving, from the first querying device or a second querying device, a second query associated with a second operation to be performed at the passive device, where the second operation is associated with a second priority level and includes a second write operation, a second read operation, or both. The operations of 1815 may be performed in accordance with examples as disclosed herein. In some examples, aspects of the operations of 1815 may be performed by a query receiving manager 1125 as described with reference to FIG. 11.

At 1820, the method may include receiving the second priority level via the second query. The operations of 1820 may be performed in accordance with examples as disclosed herein. In some examples, aspects of the operations of 1820 may be performed by a query receiving manager 1125 as described with reference to FIG. 11.

At 1825, the method may include transmitting, to the first querying device, the second querying device, or both, a message indicating a status of the first operation, the second operation, or both, where transmitting the message is based on the first priority level, the second priority level, or both. The operations of 1825 may be performed in accordance with examples as disclosed herein. In some examples, aspects of the operations of 1825 may be performed by a status message transmitting manager 1130 as described with reference to FIG. 11.

At 1830, the method may include performing one of the first operation or the second operation in accordance with the first priority level and the second priority level and based on transmitting the message. The operations of 1830 may be performed in accordance with examples as disclosed herein. In some examples, aspects of the operations of 1830 may be performed by an operation manager 1135 as described with reference to FIG. 11.

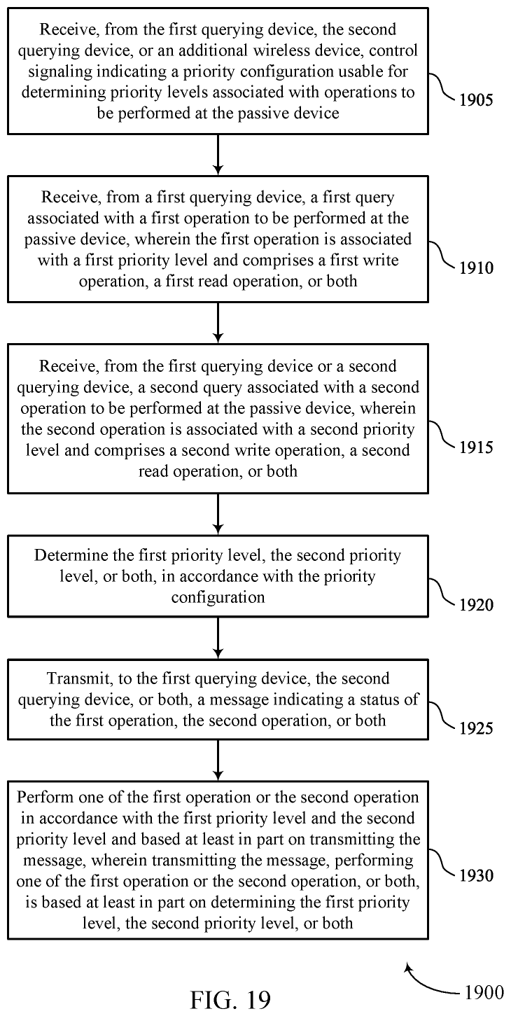

FIG. 19 shows a flowchart illustrating a method 1900 that supports techniques for prioritizing and handling conflicting read and write commands for passive devices in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include receiving, from the first querying device, the second querying device, or an additional wireless device, control signaling indicating a priority configuration usable for determining priority levels associated with operations to be performed at the passive device. The operations of 1905 may be performed in accordance with examples as disclosed herein. In some examples, aspects of the operations of 1905 may be performed by a control signaling receiving manager 1140 as described with reference to FIG. 11.

At 1910, the method may include receiving, from a first querying device, a first query associated with a first operation to be performed at the passive device, where the first operation is associated with a first priority level and includes a first write operation, a first read operation, or both. The operations of 1910 may be performed in accordance with examples as disclosed herein. In some examples, aspects of the operations of 1910 may be performed by a query receiving manager 1125 as described with reference to FIG. 11.

At 1915, the method may include receiving, from the first querying device or a second querying device, a second query associated with a second operation to be performed at the passive device, where the second operation is associated with a second priority level and includes a second write operation, a second read operation, or both. The operations of 1915 may be performed in accordance with examples as disclosed herein. In some examples, aspects of the operations of 1915 may be performed by a query receiving manager 1125 as described with reference to FIG. 11.

At 1920, the method may include determining the first priority level, the second priority level, or both, in accordance with the priority configuration. The operations of 1920 may be performed in accordance with examples as disclosed herein. In some examples, aspects of the operations of 1920 may be performed by a prioritization manager 1145 as described with reference to FIG. 11.

At 1925, the method may include transmitting, to the first querying device, the second querying device, or both, a message indicating a status of the first operation, the second operation, or both. The operations of 1925 may be performed in accordance with examples as disclosed herein. In some examples, aspects of the operations of 1925 may be performed by a status message transmitting manager 1130 as described with reference to FIG. 11.

At 1930, the method may include performing one of the first operation or the second operation in accordance with the first priority level and the second priority level and based on transmitting the message, where transmitting the message, performing one of the first operation or the second operation, or both, is based on determining the first priority level, the second priority level, or both. The operations of 1930 may be performed in accordance with examples as disclosed herein. In some examples, aspects of the operations of 1930 may be performed by an operation manager 1135 as described with reference to FIG. 11.

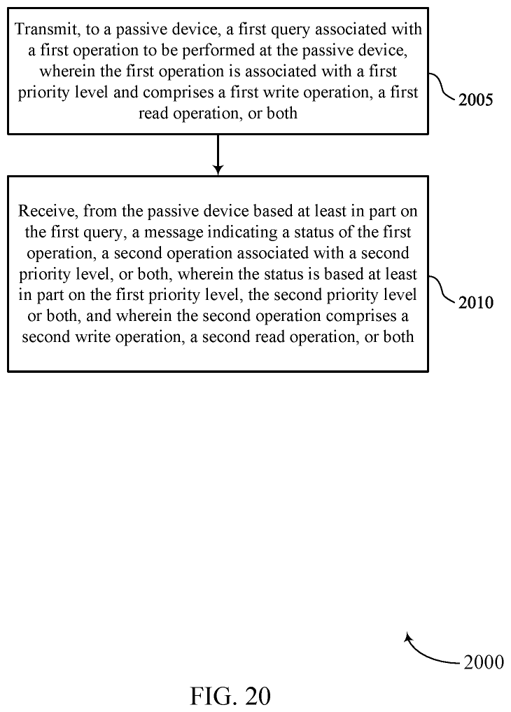

FIG. 20 shows a flowchart illustrating a method 2000 that supports techniques for prioritizing and handling conflicting read and write commands for passive devices in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a passive device, a first query associated with a first operation to be performed at the passive device, where the first operation is associated with a first priority level and includes a first write operation, a first read operation, or both. The operations of 2005 may be performed in accordance with examples as disclosed herein. In some examples, aspects of the operations of 2005 may be performed by a query transmitting manager 1525 as described with reference to FIG. 15.

At 2010, the method may include receiving, from the passive device based on the first query, a message indicating a status of the first operation, a second operation associated with a second priority level, or both, where the status is based on the first priority level, the second priority level or both, and where the second operation includes a second write operation, a second read operation, or both. The operations of 2010 may be performed in accordance with examples as disclosed herein. In some examples, aspects of the operations of 2010 may be performed by a status message receiving manager 1530 as described with reference to FIG. 15.

The following provides an overview of aspects of the present disclosure:

Aspect 1: A method for wireless communication at a passive device, comprising: receiving, from a first querying device, a first query associated with a first operation to be performed at the passive device, wherein the first operation is associated with a first priority level and comprises a first write operation, a first read operation, or both; receiving, from the first querying device or a second querying device, a second query associated with a second operation to be performed at the passive device, wherein the second operation is associated with a second priority level and comprises a second write operation, a second read operation, or both; transmitting, to the first querying device, the second querying device, or both, a message indicating a status of the first operation, the second operation, or both; and performing one of the first operation or the second operation in accordance with the first priority level and the second priority level and based at least in part on transmitting the message.

Aspect 2: The method of aspect 1, further comprising: receiving the first priority level via the first query; and receiving the second priority level via the second query, wherein transmitting the message is based at least in part on the first priority level, the second priority level, or both.

Aspect 3: The method of any of aspects 1 through 2, wherein the first priority level is based at least in part on the first operation comprising the first write operation, and the second priority level is based at least in part on the second operation comprising the second read operation.

Aspect 4: The method of aspect 3, further comprising: prioritizing the first operation over the second read operation based at least in part on the first priority level being greater than the second priority level, wherein transmitting the message is based at least in part on the prioritizing, and wherein performing one of the first operation or the second operation comprises performing the first operation based at least in part on the prioritizing.

Aspect 5: The method of any of aspects 1 through 4, further comprising: receiving, from the first querying device, the second querying device, or an additional wireless device, control signaling indicating a priority configuration usable for determining priority levels associated with operations to be performed at the passive device; and determining the first priority level, the second priority level, or both, in accordance with the priority configuration, wherein transmitting the message, performing one of the first operation or the second operation, or both, is based at least in part on determining the first priority level, the second priority level, or both.

Aspect 6: The method of aspect 5, wherein the priority configuration includes one or more rules, one or more conditions, or both, for determining priority levels associated with operations to be performed at the passive device, determining the first priority level, the second priority level, or both, is based at least in part on the one or more rules, the one or more conditions, or both.

Aspect 7: The method of any of aspects 1 through 6, wherein the first priority level is based at least in part on a first operation type associated with the first operation, and the second priority level is based at least in part on a second operation type associated with the second operation.

Aspect 8: The method of any of aspects 1 through 7, wherein the second query is received from the second querying device, and the first priority level is based at least in part on a first identifier associated with the first querying device, and the second priority level is based at least in part on a second identifier associated with the second querying device.

Aspect 9: The method of any of aspects 1 through 8, further comprising: transmitting the message to at least the second querying device based at least in part on the first priority level being greater than the second priority level, wherein the message comprises an indication that the passive device is busy performing the first operation.

Aspect 10: The method of any of aspects 1 through 9, further comprising: transmitting the message to at least the first querying device based at least in part on the first priority level being less than the second priority level, wherein the message comprises an indication that the passive device has received the second query for the second operation having a higher priority than the first operation.

Aspect 11: The method of any of aspects 1 through 10, further comprising: transmitting, via the message, an indication of the first priority level, the second priority level, a first operation type associated with the first operation, a second operation type associated with the second operation, a first identifier associated with the first querying device, a second identifier associated with the second querying device, or any combination thereof.

Aspect 12: The method of any of aspects 1 through 11, wherein the second query is received from the first querying device, the method further comprising: receiving, via the second query, an instruction to stop the first operation and to perform the second operation, wherein the passive device performs the second operation based at least in part on the instruction.

Aspect 13: The method of any of aspects 1 through 12, further comprising: transmitting a plurality of messages in accordance with a periodicity, the plurality of messages associated with a queue of operations to be performed by the passive device, the plurality of messages including the message indicating the status of the first operation, the second operation, or both.

Aspect 14: The method of aspect 13, further comprising: receiving a plurality of signals in accordance with the periodicity, wherein transmitting the plurality of messages is based at least in part on receiving the plurality of signals.

Aspect 15: The method of any of aspects 1 through 14, wherein the message comprises an indication that the passive device is busy performing the first operation, the method further comprising: receiving, from the second querying device and in response to the message, a request for an identifier associated with the first querying device; and transmitting a second message to the second querying device based at least in part on receiving the request, the second message indicating the identifier associated with the first querying device.

Aspect 16: The method of any of aspects 1 through 15, wherein performing one of the first operation or the second operation comprises performing the first operation at a first time, the method further comprising: performing the second operation at a second time subsequent to the first time based at least in part on the second priority level being less than the first priority level.

Aspect 17: The method of any of aspects 1 through 16, wherein performing one of the first operation or the second operation comprises performing one of the first write operation or the second write operation, wherein performing one of the first write operation or the second write operation comprises: adjusting one or more operational parameters at the passive device.

Aspect 18: The method of any of aspects 1 through 17, wherein performing one of the first operation or the second operation comprises performing one of the first read operation or the second read operation, wherein performing one of the first read operation or the second read operation comprises: transmitting a data message to the first querying device, the second querying device, or both.

Aspect 19: The method of any of aspects 1 through 18, wherein the passive device comprises a radio frequency identifier tag, a passive component of a wireless device, or both, and the first querying device, the second querying device, or both, comprise a UE, a network entity, or both.

Aspect 20: A method for wireless communication at a querying device, comprising: transmitting, to a passive device, a first query associated with a first operation to be performed at the passive device, wherein the first operation is associated with a first priority level and comprises a first write operation, a first read operation, or both; and receiving, from the passive device based at least in part on the first query, a message indicating a status of the first operation, a second operation associated with a second priority level, or both, wherein the status is based at least in part on the first priority level, the second priority level or both, and wherein the second operation comprises a second write operation, a second read operation, or both.

Aspect 21: The method of aspect 20, further comprising: receiving, from the passive device, a second message comprising an indicator associated with a second querying device and a request to stop an operation to be performed at the passive device that was initiated by the second querying device; and transmitting, to the second querying device based at least in part on the second message, a third message indicating the request for the second querying device to stop the operation initiated by the second querying device.

Aspect 22: The method of any of aspects 20 through 21, further comprising: transmitting the first priority level via the first query, wherein receiving the message is based at least in part on the first priority level.

Aspect 23: The method of any of aspects 20 through 22, wherein the first priority level is based at least in part on the first operation comprising the first write operation or the first read operation, and wherein the second priority level is based at least in part on the second operation comprising the second write operation or the second read operation, or wherein the first priority level is based at least in part on a first operation type associated with the first operation, and wherein the second priority level is based at least in part on a second operation type associated with the second operation

Aspect 24: The method of any of aspects 20 through 23, further comprising: transmitting, to the passive device, control signaling indicating a priority configuration usable for determining priority levels associated with operations to be performed at the passive device, wherein receiving the message is based at least in part on the priority configuration.

Aspect 25: The method of any of aspects 20 through 24, further comprising: receiving the message from the passive device based at least in part on the first priority level being less than the second priority level, wherein the message comprises an indication that the second operation has a higher priority than the first operation.

Aspect 26: The method of any of aspects 20 through 25, further comprising: receiving the message from the passive device based at least in part on the first priority level being less than the second priority level, wherein the message comprises an indication that the second operation has a higher priority than the first operation, wherein the second operation is associated with a second querying device.

Aspect 27: The method of aspect 26, further comprising: transmitting, to the passive device and in response to the message, a request for an identifier associated with the second querying device; receiving a second message from the passive device based at least in part on transmitting the request, the second message indicating the identifier associated with the second querying device; and transmitting a third message to the second querying device based at least in part on receiving the second message, the third message comprising a second request for the second querying device to stop the second operation.

Aspect 28: The method of any of aspects 20 through 27, further comprising: transmitting, to the passive device, a second query associated with the second operation, wherein the second query comprises an instruction for the passive device to stop the first operation and to perform the second operation.

Aspect 29: An apparatus for wireless communication at a passive device, comprising a processor; memory coupled with the processor; and instructions stored in the memory and executable by the processor to cause the apparatus to perform a method of any of aspects 1 through 19.

Aspect 30: An apparatus for wireless communication at a passive device, comprising at least one means for performing a method of any of aspects 1 through 19.

Aspect 31: A non-transitory computer-readable medium storing code for wireless communication at a passive device, the code comprising instructions executable by a processor to perform a method of any of aspects 1 through 19.

Aspect 32: An apparatus for wireless communication at a querying device, comprising a processor; memory coupled with the processor; and instructions stored in the memory and executable by the processor to cause the apparatus to perform a method of any of aspects 20 through 28.

Aspect 33: An apparatus for wireless communication at a querying device, comprising at least one means for performing a method of any of aspects 20 through 28.

Aspect 34: A non-transitory computer-readable medium storing code for wireless communication at a querying device, the code comprising instructions executable by a processor to perform a method of any of aspects 20 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a passive device, comprising:
a processor;
memory coupled with the processor; and
instructions stored in the memory and executable by the processor to cause the apparatus to:
receive, from a first querying device, a first query associated with a first operation to be performed at the passive device, wherein the first operation is associated with a first priority level and comprises a first write operation, a first read operation, or both;
receive, from the first querying device or a second querying device, a second query associated with a second operation to be performed at the passive device, wherein the second operation is associated with a second priority level and comprises a second write operation, a second read operation, or both;
transmit, to the first querying device, the second querying device, or both, a message indicating a status of the first operation, the second operation, or both; and
perform one of the first operation or the second operation in accordance with the first priority level and the second priority level and based at least in part on transmitting the message.

2. The apparatus of claim 1, wherein the instructions are further executable by the processor to cause the apparatus to:
receive the first priority level via the first query; and
receive the second priority level via the second query, wherein transmitting the message is based at least in part on the first priority level, the second priority level, or both.

3. The apparatus of claim 1, wherein the first priority level is based at least in part on the first operation comprising the first write operation, and wherein the second priority level is based at least in part on the second operation comprising the second read operation.

4. The apparatus of claim 3, wherein the instructions are further executable by the processor to cause the apparatus to:
prioritize the first operation over the second read operation based at least in part on the first priority level being greater than the second priority level, wherein transmitting the message is based at least in part on the prioritizing, and wherein performing one of the first operation or the second operation comprises performing the first operation based at least in part on the prioritizing.

5. The apparatus of claim 1, wherein the instructions are further executable by the processor to cause the apparatus to:
receive, from the first querying device, the second querying device, or an additional wireless device, control signaling indicating a priority configuration usable for determining priority levels associated with operations to be performed at the passive device; and
determine the first priority level, the second priority level, or both, in accordance with the priority configuration, wherein transmitting the message, performing one of the first operation or the second operation, or both, is based at least in part on determining the first priority level, the second priority level, or both.

6. The apparatus of claim 5, wherein the priority configuration includes one or more rules, one or more conditions, or both, for determining priority levels associated with operations to be performed at the passive device, wherein determining the first priority level, the second priority level, or both, is based at least in part on the one or more rules, the one or more conditions, or both.

7. The apparatus of claim 1, wherein the first priority level is based at least in part on a first operation type associated with the first operation, and wherein the second priority level is based at least in part on a second operation type associated with the second operation.

8. The apparatus of claim 1, wherein the second query is received from the second querying device, and wherein the first priority level is based at least in part on a first identifier associated with the first querying device, and wherein the second priority level is based at least in part on a second identifier associated with the second querying device.

9. The apparatus of claim 1, wherein the instructions are further executable by the processor to cause the apparatus to:
transmit the message to at least the second querying device based at least in part on the first priority level being greater than the second priority level, wherein the message comprises an indication that the passive device is busy performing the first operation.

10. The apparatus of claim 1, wherein the instructions are further executable by the processor to cause the apparatus to:
transmit the message to at least the first querying device based at least in part on the first priority level being less than the second priority level, wherein the message comprises an indication that the passive device has received the second query for the second operation having a higher priority than the first operation.

11. The apparatus of claim 1, wherein the instructions are further executable by the processor to cause the apparatus to:
transmit, via the message, an indication of the first priority level, the second priority level, a first operation type associated with the first operation, a second operation type associated with the second operation, a first identifier associated with the first querying device, a second identifier associated with the second querying device, or any combination thereof.

12. The apparatus of claim 1, wherein the second query is received from the first querying device, and the instructions are further executable by the processor to cause the apparatus to:
receive, via the second query, an instruction to stop the first operation and to perform the second operation, wherein the passive device performs the second operation based at least in part on the instruction.

13. The apparatus of claim 1, wherein the instructions are further executable by the processor to cause the apparatus to:
transmit a plurality of messages in accordance with a periodicity, the plurality of messages associated with a queue of operations to be performed by the passive device, the plurality of messages including the message indicating the status of the first operation, the second operation, or both.

14. The apparatus of claim 13, wherein the instructions are further executable by the processor to cause the apparatus to:
receive a plurality of signals in accordance with the periodicity, wherein transmitting the plurality of messages is based at least in part on receiving the plurality of signals.

15. The apparatus of claim 1, wherein the message comprises an indication that the passive device is busy performing the first operation, and the instructions are further executable by the processor to cause the apparatus to:
receive, from the second querying device and in response to the message, a request for an identifier associated with the first querying device; and
transmit a second message to the second querying device based at least in part on receiving the request, the second message indicating the identifier associated with the first querying device.

16. The apparatus of claim 1, wherein performing one of the first operation or the second operation comprises performing the first operation at a first time, and the instructions are further executable by the processor to cause the apparatus to:
perform the second operation at a second time subsequent to the first time based at least in part on the second priority level being less than the first priority level.

17. The apparatus of claim 1, wherein the instructions to perform one of the first write operation or the second write operation are executable by the processor to cause the apparatus to:
adjust one or more operational parameters at the passive device.

18. The apparatus of claim 1, wherein the instructions to perform one of the first read operation or the second read operation are executable by the processor to cause the apparatus to:
transmit a data message to the first querying device, the second querying device, or both.

19. The apparatus of claim 1, wherein the passive device comprises a radio frequency identifier tag, a passive component of a wireless device, or both, and wherein the first querying device, the second querying device, or both, comprise a user equipment (UE), a network entity, or both.

20. An apparatus for wireless communication at a querying device, comprising:
a processor;
memory coupled with the processor; and
instructions stored in the memory and executable by the processor to cause the apparatus to:
transmit, to a passive device, a first query associated with a first operation to be performed at the passive device, wherein the first operation is associated with a first priority level and comprises a first write operation, a first read operation, or both; and
receive, from the passive device based at least in part on the first query, a message indicating a status of the first operation, a second operation associated with a second priority level, or both, wherein the status is based at least in part on the first priority level, the second priority level or both, and wherein the second operation comprises a second write operation, a second read operation, or both.

21. The apparatus of claim 20, wherein the instructions are further executable by the processor to cause the apparatus to:
receive, from the passive device, a second message comprising an indicator associated with a second querying device and a request to stop an operation to be performed at the passive device that was initiated by the second querying device; and
transmitting, to the second querying device based at least in part on the second message, a third message indicating the request for the second querying device to stop the operation initiated by the second querying device.

22. The apparatus of claim 20, wherein the instructions are further executable by the processor to cause the apparatus to:
transmit the first priority level via the first query, wherein receiving the message is based at least in part on the first priority level.

23. The apparatus of claim 20,
wherein the first priority level is based at least in part on the first operation comprising the first write operation or the first read operation, and wherein the second priority level is based at least in part on the second operation comprising the second write operation or the second read operation, or
wherein the first priority level is based at least in part on a first operation type associated with the first operation, and wherein the second priority level is based at least in part on a second operation type associated with the second operation.

24. The apparatus of claim 20, wherein the instructions are further executable by the processor to cause the apparatus to:
transmit, to the passive device, control signaling indicating a priority configuration usable for determining priority levels associated with operations to be performed at the passive device, wherein receiving the message is based at least in part on the priority configuration.

25. The apparatus of claim 20, wherein the instructions are further executable by the processor to cause the apparatus to:
receive the message from the passive device based at least in part on the first priority level being less than the second priority level, wherein the message comprises an indication that the second operation has a higher priority than the first operation.

26. The apparatus of claim 20, wherein the instructions are further executable by the processor to cause the apparatus to:
receive the message from the passive device based at least in part on the first priority level being less than the second priority level, wherein the message comprises an indication that the second operation has a higher priority than the first operation, wherein the second operation is associated with a second querying device.

27. The apparatus of claim 26, wherein the instructions are further executable by the processor to cause the apparatus to:
transmit, to the passive device and in response to the message, a request for an identifier associated with the second querying device;
receive a second message from the passive device based at least in part on transmitting the request, the second message indicating the identifier associated with the second querying device; and
transmit a third message to the second querying device based at least in part on receiving the second message, the third message comprising a second request for the second querying device to stop the second operation.

28. The apparatus of claim 20, wherein the instructions are further executable by the processor to cause the apparatus to:
transmit, to the passive device, a second query associated with the second operation, wherein the second query comprises an instruction for the passive device to stop the first operation and to perform the second operation.

29. A method for wireless communication at a passive device, comprising:
receiving, from a first querying device, a first query associated with a first operation to be performed at the passive device, wherein the first operation is associated with a first priority level and comprises a first write operation, a first read operation, or both;
receiving, from the first querying device or a second querying device, a second query associated with a second operation to be performed at the passive device, wherein the second operation is associated with a second priority level and comprises a second write operation, a second read operation, or both;
transmitting, to the first querying device, the second querying device, or both, a message indicating a status of the first operation, the second operation, or both; and
performing one of the first operation or the second operation in accordance with the first priority level and the second priority level and based at least in part on transmitting the message.

30. A method for wireless communication at a querying device, comprising:
transmitting, to a passive device, a first query associated with a first operation to be performed at the passive device, wherein the first operation is associated with a first priority level and comprises a first write operation, a first read operation, or both; and
receiving, from the passive device based at least in part on the first query, a message indicating a status of the first operation, a second operation associated with a second priority level, or both, wherein the status is based at least in part on the first priority level, the second priority level or both, and wherein the second operation comprises a second write operation, a second read operation, or both.
